(19) United States
(12) Patent Application Publication
(10) Pub. No.: US 2005/0238865 A1
(43) Pub. Date: Oct. 27, 2005

(54) Plastic fiber molding, manufacturing method of plastic fiber molding and manufacturing apparatus for plastic fiber board

(75) Inventor: Masao Konishi, Chita-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TOPIA CO., LTD., Anjo-shi (JP)

(21) Appl. No.: 11/110,811

(22) Filed: Apr. 21, 2005

(30) Foreign Application Priority Data
Apr. 23, 2004 (JP) 2004-127798

(51) Int. Cl. H05B 6/64; B32B 5/02

(52) U.S. Cl. 428/292.1; 264/460; 264/489; 425/174.4; 425/407; 428/374

(57) ABSTRACT

Plastic fibers and plant fiber such as thinned woods, scrap woods of buildings, stumps, branches or barks are stirred and mixed with each other into a felt-like material. Microwaves are radiated on the felt-like fiber mixture material. After a sufficient temperature is ensured for the felt-like fiber mixture material of low density by the microwave radiation, the fiber mixture material is fed to a pair of upper and lower pressure plates and compressed thereat. The fiber mixture material is rapidly compressed by the pressure plates so as to be melted and integrated. Then, the fiber mixture material is cooled so as to be further packed by such cooling, thereby becoming a stronger plastic fiber board.

### BACKGROUND OF THE INVENTION

1. Field of the Invention

This invention relates to a plastic fiber molding, a manufacturing method of a plastic fiber molding and a manufacturing apparatus of a plastic fiber molding or a plastic fiber board that is made of a mixture of plant fibers and thermoplastic resin fibers. This invention is applicable to a construction material, a building material, a packing material for physical distribution, a car interior material, other subsidiary materials and so on. The plant fibers may be fibers or fiber-like materials such as thinned woods, scrap woods of buildings, stumps, branches and barks or fibers such as wastepaper. Waste plastics or the like may be used as the thermoplastic resin fibers. Moreover, a thermosetting resin may be used if it is mixed in.

2. Description of the Related Art

Japanese Laid Open Patent Publication No. 2002-327363 discloses a technique for a composite plastic molding. In this technique, a plastic is treated by melt spinning into plastic monofilaments. Then, waste paper or wood chips or the like are fibrillated into cellulose fibers. The plastic monofilaments and the cellulose fibers are stirred into a composite fiber body. Then, a given quantity of the composite fiber body is stacked on an upper surface of a pallet or a sheet so as to be compression-molded. At this time, the technique has a melting step for melting and a cooling/solidifying step for solidification, respectively. Moreover, the composite fibers move between the two steps while being stacked on the upper surface of the pallet or the sheet.

However, the technique shown in the above patent publication makes the plastic monofilaments by melt-spinning the plastic while making the cellulose fibers by fibrillating the waste paper or the wood chips or the like, thereby making the composite fiber body by stirring and mixing the plastic monofilaments and the cellulose fibers and stacking the given quantity of the composite fiber body on the upper surface of the pallet or the sheet. The technique requires melting of the plastic fibers by pressure plates, which causes degradation of the plastic. Thus, it cannot ensure a physical strength of the molding. Moreover, it is possible that a phreatic explosion or the like be generated by influence of moisture contained in the plant fibers at the time of the heat compression molding. Therefore, it cannot ensure a stable productivity.

In case of making the plastic fibers become fused by a heat that is radiated from the upper and the lower pressure plates, it was confirmed that the entire plastic fibers were softened and melted and tended to change into a liquid or be fluidized. Particularly, the fluidizing tendency was strong for an upper surface and a lower surface that are near the pressure plates. Therefore, it was difficult to mold the fiber board in which the plastic fiber fibrils are required to exist as a mixture component. Consequently, it was impossible to expect the fiber board to have thermal aggregation for counterworking the heat of a solidification of a concrete generated at the time of construction with the concrete. As a result, the conventional technique can be used to obtain a thin plastic board, however, it cannot be used for a plastic board such as a construction material that requires a given thickness and strength.

### BRIEF SUMMARY OF THE INVENTION

In view of the above problems, an object of the present invention is to provide a plastic fiber molding, a manufacturing method of a plastic fiber molding and a manufacturing apparatus of a plastic fiber board that ensures a constant thickness and physical strength by improving adhesive function efficiently even if a waste plastic made of a mixture of different kinds of materials is used as a raw material. Specifically, it is an object of the present invention to provide a plastic fiber molding, a manufacturing method of a plastic fiber molding and a manufacturing apparatus of a plastic fiber board that improves water resistance so as to enlarge the physical strength in the plastic fiber molding using a plastic fiber material and a plant fiber material.

According to a first aspect of the invention, there is provided a plastic fiber molding obtained by heating a fiber mixture material of low density composed of plant fiber fibrils and thermoplastic fiber fibrils by microwaves so as to make the fiber mixture material in a softened state, and compressing the fiber mixture material in the softened state so as to integrate the fiber mixture material and to shape the fiber mixture material into a desired shape.

For example, the microwaves are radiated on the felt-like fiber mixture material of the plant fiber fibrils and the thermoplastic fiber fibrils so as to increase a temperature of the plant fiber fibrils in the fiber mixture material. Then, a lignin contained in the plant fiber fibrils is solubilized by an internal heat generation of the plant fiber fibrils. Then, the fiber mixture material is compressed so as to join the plant fiber fibrils partially or entirely to the thermoplastic fiber fibrils. Consequently, the thermoplastic fiber fibrils are made into the softened state and then go through a compression molding. Thus, the fiber mixture material is integrated and formed into a desired shape by an adhesive force of mainly the lignin of the plant fiber fibrils in the fiber mixture material. The thermoplastic fiber fibrils may be any material including a virgin plastic material or a recycled plastic material so far as it is a thermoplastic resin. However, the recycled plastic material is preferred, since it can reduce costs. Moreover, heating by the microwaves may be performed by a well-known microwave heating furnace or device used in a plastic industry. Furthermore, the mixture material in the softened state may be compressed by a roller or a plate body of a fixed shape. Specifically, polymers are bonded or polymerized with each other by a bond of a hydroxyl group contained in plant fibers. Then, the plastic and the plant fibers are integrated though they are incompatible with each other. Moreover, it is possible to assist absorption of heat energy against cohesive energy, which is interposed between different kinds of plastics, by using cellulose contained in a plant fiber material. Thus, it is possible to restrain and countermeasure the heat energy against a heat distortion or a phase separating phenomenon of the plastic fiber molding.

The plant fiber fibrils are a material obtained by finely fibrillating or pulverizing thinned woods, weeds or plants, waste paper or the like but not a material formed into specific fibers or fibrils. The plant fiber fibrils may be any material so far as they are entangled and stuck and mixed with each other or they are fined or minced as close as a fiber-like material. Moreover, the plastic fiber fibrils comprise a thermoplastic fiber material finely formed into a melt-spinned shape. Such finely formed plastic material may be any material so far as it is fiber-like or fibril-like by cutting or pulverizing. The plastic fiber fibrils comprise a thermoplastic material of a thin sheet or the like. Such sheet plastic material can be formed into the sheet shape by repeating cutting and pulverizing, so that the sheet plastic material may be any material so far as it is in such state.

As described above, according to the first aspect of the plastic fiber molding, the fiber mixture material of the plant fiber fibrils and the thermoplastic fiber fibrils is heated by the microwaves. Then, the thermoplastic resin of the fiber mixture material is made into the softened state. Particularly, the temperature at a plant fiber side is made higher so as to soften the thermoplastic resin around the plant fibers. Then, the fiber mixture material is compressed in such state, so that the lignin extracted from the plant fiber fibrils is entangled with the thermoplastic fiber fibrils and sinks in and stuck to a surface of the plant fiber. Thus, the fiber mixture material can be integrated firmly and rigidly and formed into a desired shape.

According to a second aspect of the invention, there is provided a plastic fiber molding obtained by heating a fiber mixture material of low density composed of plant fiber fibrils and thermoplastic fiber fibrils by microwaves so as to make the fiber mixture material in a softened state, compressing and heating the fiber mixture material, and compressing and cooling the fiber mixture material so as to integrate the fiber mixture material and to shape the fiber mixture material into a desired shape.

For example, the felt-like fiber mixture material of the plant fiber fibrils and the thermoplastic fiber fibrils is heated by the microwaves. Then, a lignin contained in the plant fiber fibrils is solubilized by an internal heat generation of the plant fiber fibrils. Then, the fiber mixture material is compressed so as to join the plant fiber fibrils to the thermoplastic fiber fibrils, while being made into the softened state. Then, the fiber mixture material is compressed and integrated and goes through a cool compression to be formed into a desired shape. Forming into the desired shape by the cool compression means printing a fixed shape of a metal mold on the fiber mixture material and hardening it by compression. A formed molded body includes a board shaped one.

Alternatively, the felt-like fiber mixture material of the plant fiber fibrils and the thermoplastic fiber fibrils is heated by the microwaves. Then, a lignin is squeezed out from the plant fiber fibrils by compressing the fiber mixture material. Moreover, the density of the fiber mixture material is increased. Then, the fiber mixture material is joined and integrated by the lignin. Thereafter, the fiber mixture material is cooled and compressed into a desired density. In this case, a distortion concurrent with hardening of a thermoplastic resin and plant fibers is absorbed by the thermoplastic resin and the plant fibers at the time of cooling and compressing. Therefore, a molded body including a board can be formed by use of a desired metal mold.

According to a third aspect of the invention, there is provided a plastic fiber molding obtained by mixing plant fiber fibrils into thermoplastic fiber fibrils so as to make a fiber mixture material of low density, heating the fiber mixture material by microwaves so as to make the fiber mixture material in a softened state, compressing the fiber mixture material, and compressing and cooling the fiber mixture material so as to form the fiber mixture material into a desired shape.

For example, the plant fiber fibrils are mixed in the thermoplastic fiber fibrils including PE (polyethylene) and PVC (polyvinyl chloride) or the like so as to make the fiber mixture material. Then, the fiber mixture material is heated by the microwaves so as to solubilize a lignin contained in the plant fiber fibrils by an internal heat generation of the plant fiber fibrils. Thereafter, the fiber mixture material is compressed to join the plant fiber fibrils to the thermoplastic fiber fibrils. Moreover, the fiber mixture material is made into the softened state and goes through a compression molding so as to be integrated. Then, the fiber mixture material goes through a cool compression to be molded into a desired shape. In this case, it is possible to restrain a phase separating phenomenon between the PE (polyethylene) and the PVC (polyvinyl chloride) even in case of the thermoplastic fiber fibrils containing the PE (polyethylene) and the PVC (polyvinyl chloride) for which there is a relatively high need for recycle.

Alternatively, the plant fiber fibrils are mixed in the thermoplastic fiber fibrils including PE (polyethylene) and PVC (polyvinyl chloride) or the like so as to make the fiber mixture material. Then, the fiber mixture material is heated by the microwaves so as to soften the fiber mixture material and then compressed to be integrated. Thereafter, the fiber mixture material is cooled and compressed to be formed into a desire shape. In this case, the fiber mixture material is compressed, while a temperature at a plant fiber side is made higher. Thus, a thermoplastic resin gets into the plant fibers, is entangled with the plant fibers and sticks to a surface of the plant fiber. Therefore, the fiber mixture material can be integrated firmly and rigidly. Moreover, the fiber mixture material can be formed into a desired shape. Furthermore, it is possible to restrain the plastic phase separating phenomenon between the PE and PVC.

In the above-mentioned plastic fiber molding, the fiber mixture material may be compressed by repeating a heat compression and a cool compression one or more times. In this case, the plastic fiber molding can be deformed step by step and an internal distortion can be lessened.

In the above-mentioned plastic fiber molding, the plastic fiber molding may comprise plural layers, each of the plural layers having a different ratio of the plant fiber fibrils and the thermoplastic fiber fibrils and the plural layers forming the fiber mixture material of low density. In this case, there can be provided a plastic fiber molding having a desired mechanical strength, a desired specific gravity or a desired elasticity. Consequently, it is possible to supply a molded body having a designed strength in accordance with a use.

In the above-mentioned plastic fiber molding, the plant fiber fibrils and the thermoplastic fiber fibrils may be joined with each other by heating the fiber mixture material of low density composed of the plant fiber fibrils and the thermoplastic fiber fibrils and then compressing and heating the fiber mixture material by pressure plates so as to squeeze out lignin from the plant fiber fibrils.

For example, the low density of the fiber mixture material of the plant fiber fibrils and the thermoplastic fiber fibrils is heated by the microwaves. Then, a lignin contained in the plant fiber fibrils is solubilized by an internal heat generation of the plant fiber fibrils. Thereafter, the fiber mixture material is compressed to join the plant fiber fibrils to the thermoplastic fiber fibrils. Moreover, the fiber mixture material is compressed and heated by the pressure plates so that the lignin is squeezed out from the plant fiber fibrils so as to join the plant fiber fibrils to the thermoplastic fiber fibrils.

In this case, the lignin extracted from the plant fiber fibrils adheres to the thermoplastic fiber fibrils. Therefore, it is possible to form the plastic fiber molding without making the thermoplastic resin in a melted state. Particularly, the lignin can be squeezed out from the plant fiber fibrils by heat compression of the pressure plates. Thus, the lignin can be squeezed out efficiently by the heating and compressing, thereby enabling a better adhesion.

In the above-mentioned plastic fiber molding, the plastic fiber molding may have unmelted thermoplastic fiber fibrils mixed therein, and the unmelted thermoplastic fiber fibrils are softened when receiving an external heat so as to enable the plastic fiber molding to contract.

In this case, the lignin extracted from the plant fiber fibrils is bonded to the thermoplastic fiber fibrils. Thus, when the plastic fiber molding receives an external heat of a high temperature, the unmelted thermoplastic fiber fibrils are melted so as to control a volume or dimension. Therefore, a distortion is hard to be maintained in such structure.

According to a fourth aspect of the invention, there is provided a manufacturing method of a plastic fiber molding comprising the steps of: heating a fiber mixture material of low density composed of plant fiber fibrils and thermoplastic fiber fibrils by microwaves so as to make the fiber mixture material in a softened state; and compressing the fiber mixture material in the softened state so as to weld adjacent portions of the plant fiber fibrils and the thermoplastic fiber fibrils and to shape the fiber mixture material so that part of the fiber mixture material is mixed as non-welded fibers.

For example, the fiber mixture material of the plant fiber fibrils and the thermoplastic fiber fibrils is heated by the microwaves so as to solubilize a lignin contained in the plant fiber fibrils particularly by an internal heat generation of the plant fiber fibrils in the fiber mixture material. Then, the fiber mixture material is compressed to join the plant fiber fibrils to the thermoplastic fiber fibrils and is formed into a desired shape. Thus, plant fibers absorb an internal distortion and the fiber mixture material is integrated.

Alternatively, the fiber mixture material of the plant fiber fibrils and the thermoplastic fiber fibrils is heated by the microwaves so as to make particularly the plant fibers to a high temperature in the fiber mixture material. At this time, a lignin contained in the plant fiber fibrils is solubilized by an internal heat generation of the plant fiber fibrils. Then, the fiber mixture material is compressed to join the plant fiber fibrils to the thermoplastic fiber fibrils. Moreover, the fiber mixture material is compressed and formed into a desired shape. Thus, the fiber mixture material absorbs an internal distortion and the fiber mixture material is integrated. Therefore, the thermoplastic resin is entangled with the plant fibers and sticks on the surface of the plant fibers, so that the fiber mixture material can be integrated firmly and rigidly, while being formed into a desired shape.

According to a fifth aspect of the invention, there is provided a manufacturing method of a plastic fiber molding comprising the steps of: heating a fiber mixture material of low density composed of plant fiber fibrils and thermoplastic fiber fibrils by microwaves so as to make the fiber mixture material in a softened state; compressing the fiber mixture material so as to integrate the fiber mixture material: and then cooling an compressing the fiber mixture material at the same time.

For example, the fiber mixture material of the plant fiber fibrils and the thermoplastic fiber fibrils is heated by the microwaves so as to solubilize a lignin contained in the plant fiber fibrils particularly by an internal heat generation of the plant fiber fibrils in the fiber mixture material. Then, the fiber mixture material is compressed to join the plant fiber fibrils to the thermoplastic fiber fibrils and is then compressed to be formed into a fixed shape. Thus, the plant fibers absorb an internal distortion and the fiber mixture material is cooled and compressed to be integrated in a desired shape.

Alternatively, the fiber mixture material of the plant fiber fibrils and the thermoplastic fiber fibrils is heated by the microwaves so as to make particularly the plant fibers to a high temperature in the fiber mixture material. At this time, a lignin contained in the plant fiber fibrils is solubilized by an internal heat generation of the plant fiber fibrils. Then, the fiber mixture material is compressed to join the plant fiber fibrils to the thermoplastic fiber fibrils. Moreover, the fiber mixture material is compressed and formed into a desired shape. Thus, the fiber mixture material absorbs an internal distortion and the fiber mixture material is integrated. Therefore, since the fiber mixture material is cooled and compressed while the thermoplastic resin is entangled with the plant fibers and sticks on the surface of the plant fibers, the fiber mixture material can be integrated firmly and rigidly, while being formed into a desired shape.

According to a sixth aspect of the invention, there is provided a manufacturing method of a plastic fiber molding comprising the steps of: mixing plant fiber fibrils and thermoplastic fiber fibrils so as to make a fiber mixture material of low density; heating the fiber mixture material by microwaves so as to make the fiber mixture material in a softened state; and compressing and cooling the fiber mixture material so as to integrate the fiber mixture material.

For example, the plant fiber fibrils are mixed in the thermoplastic fiber fibrils including one or more kinds of PE (polyethylene) and PVC (polyvinyl chloride) and the like so as to make the fiber mixture material. Then, the fiber mixture material is heated by the microwaves so as to solubilize a lignin contained in the plant fiber fibrils by an internal heat generation of the plant fiber fibrils. Thereafter, the fiber mixture material is compressed to join the plant fiber fibrils to the thermoplastic fiber fibrils. Moreover, the fiber mixture material is made into the softened state and goes through a compression molding so as to be integrated. Then, the fiber mixture material goes through a cool compression to be molded into a desired shape. Thus, the fiber mixture material is cooled and compressed into a desired shape, while the plant fibers absorb an internal distortion, there being integrated.

Alternatively, the plant fiber fibrils are mixed in the thermoplastic fiber fibrils including one or more kinds of PE (polyethylene) and PVC (polyvinyl chloride) or the like so as to make the fiber mixture material. Then, the fiber mixture material is heated by the microwaves so as to soften the fiber mixture material. Then, the fiber mixture material goes through compression molding to be integrated. Thereafter, the fiber mixture material is compressed to be formed into a fixed shape. Thus, the fiber mixture material is cooled and compressed to be formed into a desired shape,, while the plant fibers absorb an internal distortion, there being integrated. Therefore, the distortion concurrent with hardening of the thermoplastic resin is absorbed by the plant fibers, so that the molding including a board shaped one can be formed by use of a desired metal mold.

In the above-mentioned manufacturing method of a plastic fiber molding, the fiber mixture material may be compressed by repeating a heat compression and a cool compression one or more times.

Therefore, an internal distortion of the plastic fiber molding can be further reduced.

In the above-mentioned manufacturing method of a plastic fiber molding, the microwaves may have an output of 5 KW or more. In this case, particularly the plant fiber fibrils are compressed in a high temperature state and then cooled and formed into a desired shape. At that time, the fiber mixture material can be integrated, while absorbing an internal distortion through an intervention of the plant fibers.

Accordingly, the fiber mixture material is compressed while making a temperature particularly at the plant fiber side higher. Moreover, the fiber mixture material is cooled and compressed, while the thermoplastic resin is entangled with the plant fibers and sticks to the surface of the plant fibers. Therefore, the fiber mixture material can be integrated firmly and rigidly and be formed into a desired shape.

In the above-mentioned manufacturing method of a plastic fiber molding, the compressing step may comprise a heat compression by pressure plates so as to squeeze out lignin from the plant fiber fibrils and to join the plant fiber fibrils to the thermoplastic fiber fibrils.

For example, the fiber mixture material of low density made of the plant fiber fibrils and the thermoplastic fiber fibrils is heated by the microwaves so as to solubilize a lignin contained in the plant fiber fibrils by an internal heat generation of the plant fiber fibrils. Then, the fiber mixture material is compressed to join the plant fiber fibrils to the thermoplastic fiber fibrils. Moreover, the compression of the fiber mixture material in the softened state is heat compression by the pressure plates. Therefore, the lignin can be squeezed out from the plant fiber fibrils and be joined to the thermoplastic fiber fibrils.

Accordingly, it is possible to form the plastic fiber molding that has the lignin extracted from the plant fiber fibrils bonded to the thermoplastic fiber fibrils. Particularly, the lignin can be squeezed out from the plant fiber fibrils by the heat compression of the pressure plates. Moreover, since the fiber mixture material is heated by the compression, the lignin can be squeezed out efficiently by the heating and compressing. Thus, a better joining is possible.

In the above-mentioned manufacturing method of a plastic fiber molding, the compressing step may be carried out to such a degree as unmelted thermoplastic fiber fibrils are mixed in the plastic fiber molding and the unmelted thermoplastic fiber fibrils enable the plastic fiber molding to contract when receiving an external heat.

For example, the fiber mixture material in the low density made of the plant fiber fibrils and the thermoplastic fiber fibrils is heated by the microwaves so as to solubilize a lignin contained in the plant fiber fibrils by an internal heat generation of the plant fiber fibrils. Then, the fiber mixture material is compressed to join the plant fiber fibrils to the thermoplastic fiber fibrils. Moreover, the compression of the fiber mixture material in the softened state is carried out to such a degree as the unmelted thermoplastic fiber fibrils are mixed in the fiber mixture material so as to enable the fiber mixture material to contract when receiving an external heat.

Accordingly, the lignin extracted from the plant fiber fibrils is bonded to the thermoplastic fiber fibrils. Thus, when the fiber mixture material receives the external heat of a high temperature, the unmelted thermoplastic fiber fibrils are melted so as to control a volume of the fiber mixture material. Consequently, there is provided a structure in which a distortion is hard to remain.

According to a seventh aspect of the invention, there is provided a manufacturing apparatus of a plastic fiber molding comprising: a heating unit for heating a fiber mixture material composed of plant fiber fibrils and thermoplastic fiber fibrils by microwaves so as to make the fiber mixture material in a softened state; and a compression unit for compressing the fiber mixture material so as to form the fiber mixture material into a desired shape.

Moreover, according to an eighth aspect of the invention, there is provided a manufacturing apparatus of a plastic fiber molding comprising: a heating unit for heating a fiber mixture material composed of plant fiber fibrils and thermoplastic fiber fibrils by microwaves so as to make the fiber mixture material in a softened state; and a cool-compression unit for cooling and compressing the fiber mixture material so as to form the fiber mixture material into a desired shape.

For example, the manufacturing apparatus of the plastic fiber molding heats the fiber mixture material f the plant fiber fibrils and the thermoplastic fiber fibrils by the microwaves so as to solubilize a lignin contained in the plant fiber fibrils by an internal heat generation of the plant fiber fibrils. Then, the apparatus compresses the fiber mixture material so as to join the plant fiber fibrils to the thermoplastic fiber fibrils. At this time, the plastic fiber fibrils of the fiber mixture material receives heat from the plant fiber fibrils to become a softened state. Then, the apparatus compresses the fiber mixture material in non-melted state. Thereafter, the apparatus gives a cool compression to the fiber mixture material so as to integrate the fiber mixture material and form it into a predetermined shape.

Alternatively, the manufacturing apparatus of the plastic fiber molding heats the fiber mixture material f the plant fiber fibrils and the thermoplastic fiber fibrils by the microwaves so as to solubilize a lignin contained in the plant fiber fibrils by an internal heat generation of the plant fiber fibrils and to make the fiber mixture material into the softened state. Then, the apparatus compresses the fiber mixture material in the softened state and then compresses and cools at the same time so as to integrate the fiber mixture material and to form it into a fixed shape. Particularly, the apparatus makes a temperature at a plant fiber side higher and compresses the fiber mixture material in such state. Thus, the apparatus carries out a cool compression while a thermoplastic resin is entangled with the plant fibers and sticks to a surface of the plant fibers. Therefore, the apparatus can integrate the fiber mixture material firmly and rigidly and form it into a desired shape.

According to a ninth aspect of the invention, there is provided a manufacturing apparatus of a plastic fiber molding comprising: a heating unit for heating a fiber mixture material composed of plant fiber fibrils and thermoplastic fiber fibrils by microwaves so as to make the fiber mixture material in a softened state; a compression unit for compressing and integrating the fiber mixture material, the compression unit has a first pair of upper and lower pressure plates of a predetermined shape and a first pair of separating means disposed between the first pair of the upper and lower pressure plates and the fiber mixture material; and a cool-compression unit for cooling and compressing the fiber mixture material so as to form the fiber mixture material into a desired shape, the cool-compression unit has a second pair of upper and lower second pressure plates of a predetermined shape and a second pair of separating means disposed between the first pair of the upper and lower second pressure plates and the fiber mixture material; wherein the fiber mixture material is compressed and formed while held between the first pair of the separating means in the compression unit and the fiber mixture material is compressed and formed while held between the second pair of the separating means in the cool-compression unit.

For example, the manufacturing apparatus of the plastic fiber molding heats the fiber mixture material f the plant fiber fibrils and the thermoplastic fiber fibrils by the microwaves so as to solubilize a lignin contained in the plant fiber fibrils by an internal heat generation of the plant fiber fibrils. Then, the apparatus compresses the fiber mixture material so as to join the plant fiber fibrils to the thermoplastic fiber fibrils and to soften the fiber mixture material. Then, the apparatus compresses and integrate the fiber mixture material. Thereafter, the apparatus cools and compresses the fiber mixture material so as to form it into a predetermined shape. Such compression works use the first and second pairs of the upper and lower pressure plates and the first and second pairs of the separating means disposed between the first and second pairs of the upper and lower pressure plates and the fiber mixture material. The apparatus compresses and molds the fiber mixture material while holding the fiber mixture material between the pair of the separating means.

Particularly, the apparatus makes a temperature at a plant fiber side higher and compresses the fiber mixture material in such state. Thus, the apparatus carries out a cool compression while a thermoplastic resin is entangled with the plant fibers and sticks to a surface of the plant fibers. Therefore, the apparatus can integrate the fiber mixture material firmly and rigidly and form it into a desired shape.

According to a tenth aspect of the invention, there is provided a manufacturing apparatus of a plastic fiber molding comprising: a heating unit for heating a fiber mixture material composed of plant fiber fibrils and thermoplastic fiber fibrils by microwaves so as to make the fiber mixture material in a softened state; and a compression unit for compressing and integrating the fiber mixture material so as to form the fiber mixture material into a desired shape, the compression unit has a pair of upper and lower pressure plates of a predetermined shape and a pair of separating means disposed between the pair of the upper and lower pressure plates and the fiber mixture material; wherein the fiber mixture material is fed while held between the pair of the separating means in the compression unit.

For example, the manufacturing apparatus of the plastic fiber molding heats the fiber mixture material f the plant fiber fibrils and the thermoplastic fiber fibrils by the microwaves so as to solubilize a lignin contained in the plant fiber fibrils by an internal heat generation of the plant fiber fibrils. Then, the apparatus compresses the fiber mixture material so as to join the plant fiber fibrils to the thermoplastic fiber fibrils and to soften the fiber mixture material. Then, the apparatus compresses and integrate the fiber mixture material. Thereafter, the apparatus cools and compresses the fiber mixture material so as to form it into a predetermined shape. Such compression works use the pair of the upper and lower pressure plates and the pair of the separating means disposed between the pair of the upper and lower pressure plates and the fiber mixture material. The apparatus feeds the fiber mixture material while holding it between the pair of the separating means.

Accordingly, the apparatus can determine a finished surface by the separating means. Moreover, the apparatus can change the pair of the upper and lower pressure plates before the fiber mixture material is thoroughly cooled. Thus, the apparatus can repeat heating and cooling, thereby decreasing heat loss for repeating the heating and the cooling, while enabling a movement for integrating and molding the fiber mixture material firmly and rigidly.

According to an eleventh aspect of the invention, there is provided a manufacturing apparatus of a plastic fiber molding comprising: a heating unit for heating a fiber mixture material composed of plant fiber fibrils and thermoplastic fiber fibrils by microwaves so as to make the fiber mixture material in a softened state; and a compression unit for compressing and integrating the fiber mixture material so as to form the fiber mixture material into a desired shape, the compression unit has a pair of upper and lower pressure plates of a predetermined shape and a pair of separating means disposed between the pair of the upper and lower pressure plates and the fiber mixture material; wherein the fiber mixture material is compressed and fed while held between the pair of the separating means in the compression unit.

For example, the manufacturing apparatus of the plastic fiber molding heats the fiber mixture material f the plant fiber fibrils and the thermoplastic fiber fibrils by the microwaves so as to solubilize a lignin contained in the plant fiber fibrils by an internal heat generation of the plant fiber fibrils. Then, the apparatus compresses the fiber mixture material so as to join the plant fiber fibrils to the thermoplastic fiber fibrils and to soften the fiber mixture material. Then, the apparatus compresses and integrate the fiber mixture material. Thereafter, the apparatus cools and compresses the fiber mixture material so as to form it into a predetermined shape. Such compression works use the pair of the upper and lower pressure plates and the pair of the separating means disposed between the pair of the upper and lower pressure plates and the fiber mixture material. The apparatus compresses and feeds the fiber mixture material while holding it between the pair of the separating means.

Accordingly, the apparatus can determine a finished surface by the separating means. Moreover, the apparatus can change the pair of the upper and lower pressure plates before the fiber mixture material is thoroughly cooled. Thus, the apparatus can repeat heating and cooling, thereby enabling the fiber mixture material to be integrated firmly and rigidly and to be formed into a desired shape.

According to a twelfth aspect of the invention, there is provided a manufacturing apparatus of a plastic fiber molding comprising: a heating unit for heating a fiber mixture material composed of plant fiber fibrils and thermoplastic fiber fibrils by microwaves so as to make the fiber mixture material in a softened state; a compression unit for compressing and integrating the fiber mixture material so as to form the fiber mixture material into a desired shape; and an attenuating unit, provided at an entrance and an exit of a heating area of the heating unit, for attenuating the microwaves so that the fiber mixture material is continuously fed thereat.

For example, the manufacturing apparatus of the plastic fiber molding heats the fiber mixture material f the plant fiber fibrils and the thermoplastic fiber fibrils by the microwaves so as to solubilize a lignin contained in the plant fiber fibrils by an internal heat generation of the plant fiber fibrils. Then, the apparatus compresses the fiber mixture material so as to join the plant fiber fibrils to the thermoplastic fiber fibrils and to soften the fiber mixture material. Then, the apparatus cools and compresses the fiber mixture material so as to integrate the fiber mixture material and to form it into a fixed shape. Moreover, the apparatus provides the attenuating unit for attenuating the microwaves at the entrance and the exit of the heating area of the microwaves. Thus, the apparatus enables the fiber mixture material to be fed continuously.

Accordingly, the apparatus can construct the area for heating the fiber mixture material of the plant fiber fibrils and the thermoplastic fiber fibrils by the microwaves into the softened state and compressing the fiber mixture material, as one section of the continuously forming apparatus. Thus, the apparatus can successively and adjacently provide a structure for melting and compressing the fiber mixture material and a structure for compressing and cooling the fiber mixture material.

The above-mentioned manufacturing apparatus of a plastic fiber molding may further comprise side plates extending in a direction perpendicular to a vertical direction, the side plates being provided respectively at the heating unit and the compression unit.

For example, the apparatus uses the side plates extending in the direction perpendicular to the vertical direction when heating the fiber mixture material by the microwaves so as to solubilize a lignin contained in the plant fiber fibrils by an internal heat generation of the plant fiber fibrils, compressing it to join the plant fiber fibrils to the thermoplastic fiber fibrils and then cooling and compressing the fiber mixture material in the softened state to integrate it. In this case, a desired shape of the plastic fiber molding can be obtained regardless of a continuous molding or an injection molding. Particularly, the apparatus can continuously form the plastic fiber molding having a fixed width.

In the above-mentioned manufacturing apparatus of a plastic fiber molding, a plastic used for the thermoplastic fiber fibrils may be one of a PE (polyethylene) and a PVC (polyvinyl chloride).

In this case, the apparatus mixes the plant fiber fibrils into the thermoplastic fiber fibrils including the PE (polyethylene) and the PVC (polyvinyl chloride) so as to make the fiber mixture material. Then, the apparatus heats the fiber mixture material by the microwaves so as to soften it. Then, the apparatus compresses and molds the fiber mixture material so as to integrate it. Thus, the thermoplastic resin sinks in the plant fibers, is entangled with the plant fibers and sticks to the surface of the plant fibers. Therefore, the apparatus can integrate fiber mixture material firmly and rigidly. Moreover, the apparatus can mold the fiber mixture material into a desired shape, while restraining a plastic phase separating phenomenon between PE and PVC.

In the above-mentioned manufacturing apparatus of a plastic fiber molding, the compression unit may have pressure plates for compressing and heating the fiber mixture material in the softened state so that lignin is squeezed out from the plant fiber fibrils so as to join the plant fiber fibrils to the thermoplastic fiber fibrils.

For example, the pressure plates acts to compress the fiber mixture material in the softened state after heating the fiber mixture material of low density composed of the plant fiber fibrils and the thermoplastic fiber fibrils by the microwaves so as to solubilize the lignin contained in the plant fiber fibrils by the internal heat generation of the plant fiber fibrils, thereby joining the plant fiber fibrils to the thermoplastic fiber fibrils. Thus, the apparatus squeezes out the lignin from the from the plant fiber fibrils so as to join or bond the plant fiber fibrils to the thermoplastic fiber fibrils.

Accordingly, the apparatus can form the plastic fiber molding without making the thermoplastic in a melted state. Particularly, since the apparatus can squeeze out the lignin from the plant fiber fibrils by the heat compression of the pressure plates, the apparatus can efficiently squeeze out the lignin by heating and compressing. Thus, a better joining is possible.

In the above-mentioned manufacturing apparatus of a plastic fiber molding, the compression unit may compress the fiber mixture material in the softened state to such a degree as unmelted thermoplastic fiber fibrils are mixed in the plastic fiber molding and enable the plastic fiber molding to contract when receiving an external heat.

For example, the apparatus compress the fiber mixture material in the softened state after heating the fiber mixture material of low density composed of the plant fiber fibrils and the thermoplastic fiber fibrils by the microwaves so as to solubilize the lignin contained in the plant fiber fibrils by the internal heat generation of the plant fiber fibrils, thereby joining the plant fiber fibrils to the thermoplastic fiber fibrils, to such a degree as the unmelted thermoplastic fiber fibrils are mixed in the plastic fiber molding and enable the plastic fiber molding to contract when receiving an external heat.

In this case, the lignin extracted from the plant fiber fibrils is bonded to the thermoplastic fiber fibrils. Therefore, when the plastic fiber molding receives the external heat of a high temperature, the unmelted thermoplastic fiber fibrils are melted s as to control the volume. Thus, the plastic fiber molding has a structure in which distortion is hard to remain.

The above-mentioned plastic fiber molding may be a plastic fiber molded board in the above-mentioned plastic fiber molding, its manufacturing method and its manufacturing apparatus. In this case, it is possible to continuously form the plastic fiber molded board. Moreover, it is possible to form a board of a desired thickness and a desired width by the continuous molding.

Further objects and advantages of the invention will be apparent from the following description, reference being had to the accompanying drawings, wherein preferred embodiments of the invention are clearly shown.

### BRIEF DESCRIPTION OF THE SEVERAL VIEWS OF THE DRAWINGS

FIG. 1 is a concept view showing an overall manufacturing apparatus of a plastic fiber molding according to a first embodiment of the invention.

FIG. 2 is a schematic view showing the overall manufacturing apparatus of the plastic fiber molding according to the first embodiment of the invention.

FIG. 3 is a schematic view of an attenuating part of a microwave heating unit of the manufacturing apparatus of the plastic fiber molding according to the first embodiment of the invention.

FIG. 4 is a schematic view of side plates of a heat-compression unit of the manufacturing apparatus of the plastic fiber molding according to the first embodiment of the invention.

FIG. 5 is an explanatory drawing showing a reaction formula of a lignin and a polyethylene.

FIG. 6 is a schematic view of an overall system for a manufacturing method of a plastic fiber molding according to a second embodiment of the invention.

FIG. 7 is a graph showing a heat generating property after concrete construction.

### DETAILED DESCRIPTION OF THE INVENTION

Several embodiments of the invention are described hereunder referring to the attached drawings. The same reference character is used to show the same element throughout the several embodiments.

### First Embodiment

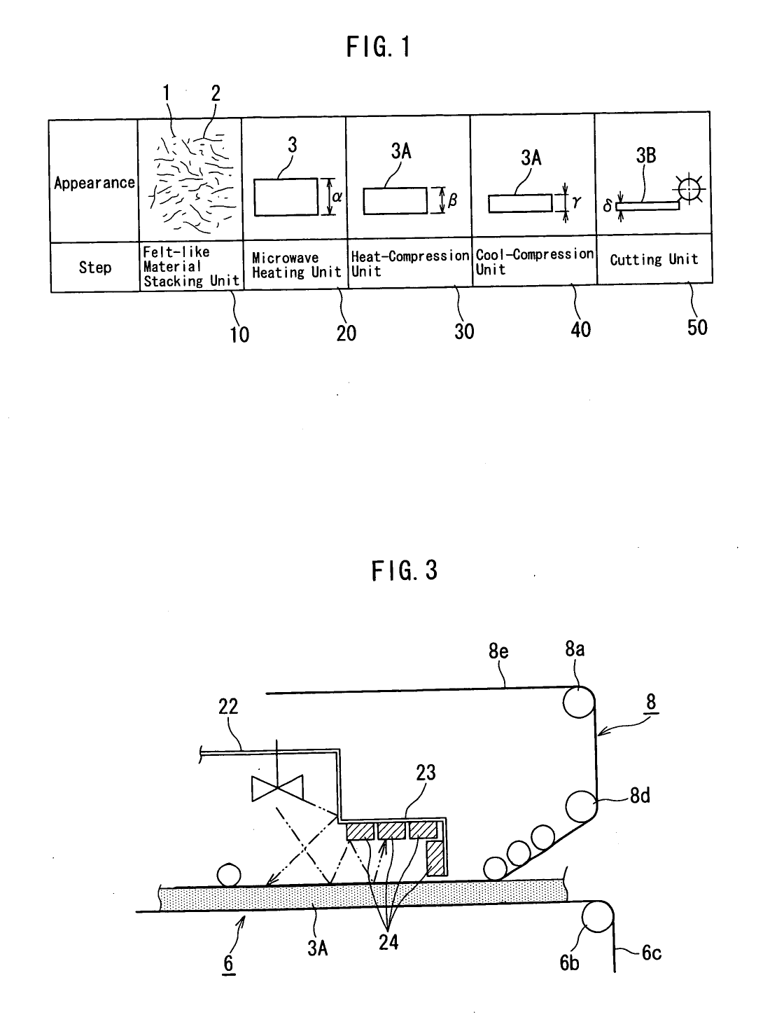

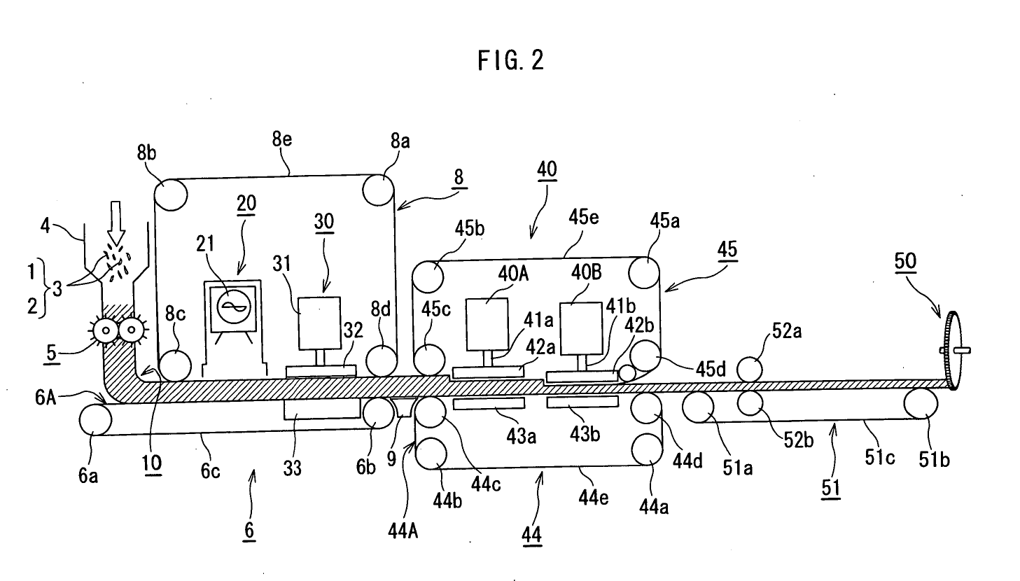

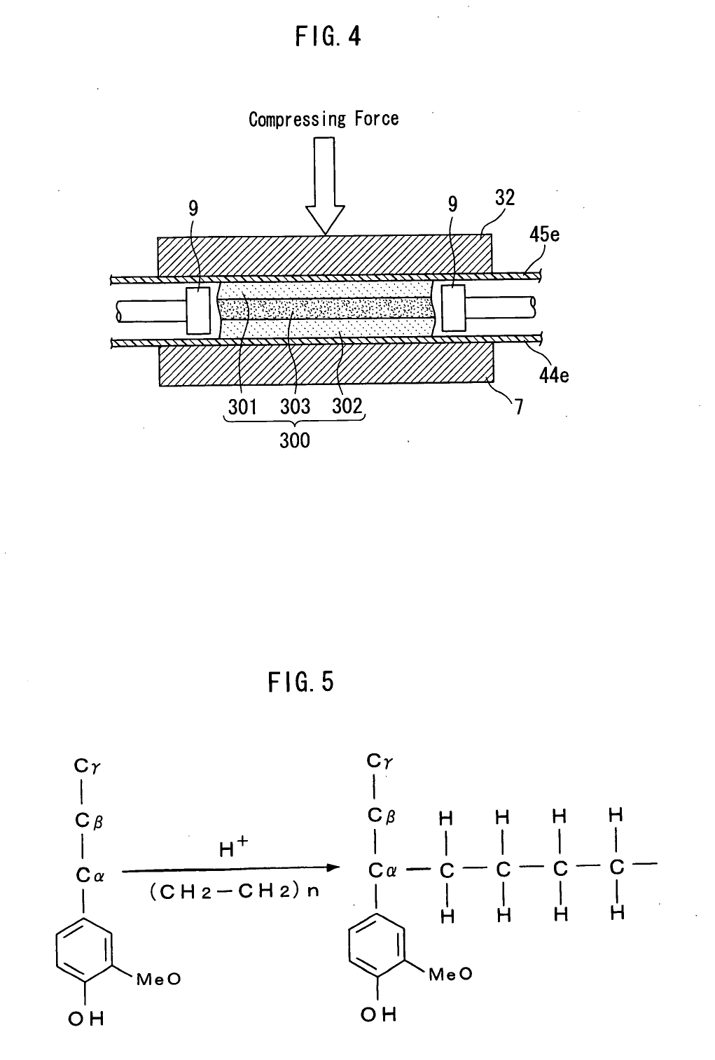

FIG. 1 is a concept view showing an overall manufacturing apparatus of a plastic fiber molding according to a first embodiment of the invention. FIG. 2 is a schematic view showing the overall manufacturing apparatus of the plastic fiber molding according to the first embodiment of the invention. FIG. 3 is a schematic view of an attenuating part of a microwave heating unit of the manufacturing apparatus of the plastic fiber molding according to the first embodiment of the invention. FIG. 4 is a schematic view of side plates of a heat-compression unit of the manufacturing apparatus of the plastic fiber molding according to the first embodiment of the invention. FIG. 5 is an explanatory drawing showing a reaction formula of a lignin and a polyethylene.

Referring to FIG. 1 to FIG. 2, a plant fiber material and a thermoplastic resin fiber material are made into a fiber mixture material 3 by an apparatus (not shown) in a manufacturing method of a plastic fiber molded body or molding according to the first embodiment. For example, thinned woods, weeds or plants, waste papers or the like are finely fibrillated or milled into a plant fiber fibril like material so as to obtain plant fiber fibrils 1. Similarly, the thermoplastic resin fiber material made of waste plastics are melted once to undergo a spinning process or pulverized into a plastic fiber fibril like material or crushed plastic pieces so as to obtain plastic fiber fibrils 2. Then, the plant fiber fibrils 1 and the plastic fiber fibrils 2 are mixed in a constant ratio to obtain a mixture thereof. The mixture is stirred to have the fiber mixture material 3 in which the fibers are piled and mixed as close as a felt. The fiber mixture material 3 is fed on a belt conveyor 6 so as to be stacked on an upper surface of the belt conveyor 6 in a low density. Then, the fiber mixture material 3 is formed into the felt like material that has a fixed thickness and a fixed width. A unit used in the above step to form the fiber mixture material 3 on the belt conveyor 6 is called felt-like material stacking unit 10. The fiber mixture material 3 formed in the felt-like material stacking unit 10 may have a desired thickness and a desired width according to a structure of the felt-like material stacking unit 10.

The plant fiber fibrils 1 are a material made by finely fibrillating or pulverizing the thinned woods, weeds or plants, waste papers or the like, however, they are not a material formed into fibrils as specific fibers. Consequently, the plant fiber fibrils 1 may be any material as long as they are broken up into fiber-like materials while they are intertwined with each other.

The thermoplastic fiber fibrils 2 are a fibril-like material made by spinning by a specific gravity or a melting temperature while using a centrifugal force in a melted state, repeating cutting and pulverizing so as to make fibers into a uniform denier so as to obtain the fiber fibril like material. However, in case of a thermoplastic resin material that is formed into a fine thread by melting and spinning, the thermoplastic fiber fibrils 2 may be ones that are made into a fiber-like material or a fibril-like material by cutting and pulverizing. Moreover, since a thermoplastic resin material having a shape such as a thin sheet can be formed into a piece of a sheet material having a thin belt shape simply by repeating cutting and pulverizing, the thermoplastic fiber fibrils 2 may be ones that are made into such state.

After the fiber mixture material 3 is stacked on the belt conveyor 6 in the felt-like material stacking unit 10, it is conveyed to a microwave heating unit 20. The fiber mixture material 3 is then heated by microwaves so that lignin contained therein is solubilized by internal heat generation of the plant fiber fibrils 1. At the same time, the fiber mixture material 3 at a heated state by the microwaves is compressed at a heat-compression unit 30. Thus, the plant fiber fibrils 1 has the lignin extracted therefrom and is integrated with the thermoplastic fiber fibrils 2 by melting so that a mixture material 3A of a high density is obtained. A unit used in a step for heating the fiber mixture material 3 by the microwaves is referred to as the microwave heating unit 20. A unit used in a step for further heating and compressing the heated fiber mixture material 3 by a heating plate or the like so as to make it into high density is referred to as the heat-compression unit 30. The fiber mixture material 3 of a thickness of α mm at the microwave heating unit 20 is heated and compressed at the heat-compression unit 30 to become the mixture material 3A of a high density having a thickness of α mm.

In detail, the fiber mixture material 3 on the belt conveyor 6 is fed to the microwave heating unit 20 and heated thereat by the microwaves at a frequency of 300 MHz to 300 GHz outputted from a microwave generator 21. Thus, the microwaves heats the plant fiber fibrils 1 having a moisture content of about 5% to 30% that constitutes the fiber mixture material 3 stacked on the belt conveyor 6. The fiber mixture material 3 stacked on the upper surface of the belt conveyor 6 is a felt-like stacked material having a density or a specific gravity of 0.4 kg/cm3 or less. The fiber mixture material 3 of a low specific gravity is heated by the microwaves while being held between a pair of upper and lower separating means.

The fiber mixture material 3 in low density has the plant fiber fibrils 1 uniformly mixed therein, while the plant fiber fibrils 1 maintain a constant moisture or preferably a moisture content of about 5% to 30%. Therefore, the plant fiber fibrils 1 generate heat first by themselves caused by heat generation of water molecules when the microwaves are radiated thereon. The thermoplastic fiber fibrils 2 are mixed uniformly with the plant fiber fibrils 1 as the fiber mixture material 3, while being entangled with the plant fiber fibrils 1. Therefore, the temperature of the thermoplastic fiber fibrils 2 increases in accordance with the heat generation and temperature rising of the plant fiber fibrils 1. Consequently, the thermoplastic fiber fibrils 2 are indirectly softened to be in a melted state.

As described above, the fiber mixture material 3 is heated by the microwave heating unit 20 and compressed by the heat-compression unit 30, so that the plant fiber fibrils 1 and the thermoplastic fiber fibrils 2 are melted and integrated in part or as a whole. Thus obtained mixture material 3A of high density is cooled and compressed further at a cool-compression unit 40. Then, the mixture material 3A is solidified and has its density heightened so as to enlarge its hardness. Specifically, after the fiber mixture material 3 is compressed at the heat-compression unit 30 so that the plant fiber fibrils 1 and the thermoplastic fiber fibrils 2 are integrally melted to provide the mixture material 3 of high density, the mixture material 3A is compressed while being cooled so as to further heighten the density thereof. A unit used in a step for cooling and compressing the mixture material 3A to heighten the density thereof is referred to as the cool-compression unit 40. The heat-compression unit 30 and the cool-compression unit 40 may be connected in series to form a plurality of stages or steps.

A cutting unit 50 is provided at a downstream of the cool-compression unit 40 if required. The cutting unit 50 performs a cutting step of ribs or a cutting step of an elongate material. For example, if the plastic fiber molding should be a molded board, the plastic fiber molding is cut into a fixed size to provide plastic fiber molded boards. Of course, if the plastic fiber molding can be taken out singly as a molded product, it is taken out one by one.

In each of the steps described above, a bulk size or height of the fiber mixture material 3 and the mixture material 3A changes as follows: the thickness of a mm at the microwave heating unit 30, the thickness of β mm at the heat-compression unit 30, a thickness of γ mm at the cool-compression unit 40 and the thickness of δ mm in a final product. Namely, the material is compressed and increases the density at each of the steps, so that the physical strength thereof is heightened step by step.

A manufacturing apparatus of a plastic fiber molding according to the first embodiment is described hereafter.

[Felt-Like Stacking Unit 10]

In FIG. 1 and FIG. 2, the plant fiber fibrils 1 are put into a hopper 4. Used as the plant fiber fibrils 1 are fibers or fiber-like materials such as thinned woods, scrap woods of buildings, branches and barks or fibers such as wastepaper. The plant fiber fibrils 1 keep moisture content of about 5% to 30%. For example, the plant fiber fibrils 1 are made by fibrillating or pulverizing the thinned woods, weeds or plants, waste papers or the like into a plant fiber fibril like material.

The thermoplastic resin fiber fibrils 2 are made by melting and spinning once or pulverizing the thermoplastic resin of waste plastics into plastic fiber fibril like material or pulverized plastic pieces.

More in detail, the thermoplastic resin made of the waste plastics is melted once and undergoes spinning by the specific gravity or the melting temperature by use of the centrifugal force so as to become threads or yarns. Then the threads or the yarns are repeatedly cut and pulverized so as to be fibers of a constant thickness, thereby forming the thermoplastic fiber fibrils 2. However, it is a matter of course that the thermoplastic resin fiber material that has undergone the melting and spinning process or the like can be made into monofilaments or single fibers by cutting and pulverizing. Moreover, the thermoplastic resin fiber material in a shape of a thin sheet or the like can be made into the sheet body having a strip shape only by repeating the cutting and the pulverizing. Such states of materials can be construed as a fiber fibril like state of the thermoplastic resin fiber material and be within a kind of the thermoplastic fiber fibrils 2. A cellulose component containing material such the thinned woods, weeds or plants or waste papers are finely fibrillated into the plant fiber fibrils 1.

The plant fiber fibrils 1 and the thermoplastic fiber fibrils 2 are mixed and stirred so that the fiber fibrils are uniformly intertwined, stuck and mixed with each other so as to form the fiber mixture material 3. In case of using an absolute dry plant fiber material, it is replenished with water in advance to keep constant the moisture content when the plant fiber fibrils 1 and the thermoplastic fiber fibrils 2 are mixed.

When a given amount of interrelated fiber fibrils of the plant fiber fibrils 1 and the thermoplastic fiber fibrils 2 are stirred and mixed, the plant fiber fibrils 1 and the thermoplastic fiber fibrils 2 are entangled with each other. Then, the fiber mixture material 3 can be made by forming the mixed fibers into a uniform thickness.

In this case, it is preferable in view of strength to mix the thermoplastic resin in a ratio of 10% or more in a total mass because it functions as a binder. In the construction material or the like, it is preferable to mix the thermoplastic fiber fibrils 2 in a ration of 50% or more in the total mass so as to improve the physical strength.

The fiber mixture material 3 having the fiber fibrils mixed and uniformly entangled with each other is put into the hopper 4 and stacked uniformly on the upper surface of the belt conveyor 6. That is, after the interrelated fibers of the plant fiber fibrils 1 and the thermoplastic fiber fibrils 2 are uniformly stirred and mixed, a give amount of the mixed fibers are dropped from a slot of the hopper 4 and stacked onto the upper surface of the belt conveyor 6. Then, the fiber mixture material 3 made of the plant fiber fibrils 1 and the thermoplastic fiber fibrils 2 are stacked on the belt conveyor 6 in a fixed amount and in a low density.

At this time, the manufacturing apparatus may be provided with a discharge device 5 having a mechanism for feeding a fixed amount of the plant fiber fibrils 1 and the thermoplastic fiber fibrils 2 outputted from the hopper 4 on the belt conveyor 6 so that the fiber mixture material 3 is uniformly stacked on the upper surface of the belt conveyor 6. Namely, the discharge device 5 serves to equalize a discharge amount from the hopper 4.

[Separating Means]

The belt conveyor 6 is composed of a drive roller 6a, a driven roller 6b and a Teflon belt 6c (Teflon is a registered trademark of DuPont). The Teflon belt 6c is put across the drive roller 6a and the driven roller 6b so as to be rotated by the rollers 6a and 6b. The belt conveyor 6 further has a material that is hard to be heated by the microwaves such as the Teflon belt 6c and a material that has a low adhesive property to the thermoplastic resin such as a wrap film, Teflon sheet, heat-resistant sheet or the like. A heated pressure plate 33 that is made of ceramics is disposed on a rear surface of the Teflon belt 6c so that the Teflon belt 6c is not bent or warped at a position corresponding to a pressure plate 32 described later.

In the first embodiment, the Teflon belt 6c has Teflon coated at least on a front surface so that the mixture material 3A in a softened state can be peeled off from the Teflon belt 6c. Moreover, in the first embodiment, the Teflon belt 6c is used as a conveyor belt in common. However, in embodying the invention, a separating means may be formed of a sheet material that has a bad adhesiveness to the thermoplastic resin such as an additional Teflon sheet or heat-resistant sheet. In the first embodiment, the belt conveyor 6 constitutes a separating means 6A for peeling the Teflon sheet corresponding to a lower separating sheet in an embodiment of the invention.

A wrap sheet 8e is rotated by four rollers 8a, 8b, 8c and 8d so as to correspond to the Teflon belt 6c of the belt conveyor 6 and cover the fiber mixture material 3 on the upper surface of the belt conveyor 6. The wrap sheet 8e is made of the material that has poor adhesiveness to the thermoplastic resin such as a Teflon sheet or a heat-resistant sheet. One of the four rollers 8a, 8b, 8c and 8d constitutes a drive roller. In embodying the invention, the separating means may be constituted such that the wrap sheet 8e is supplied from one side or an upstream side and reeled in at another side. Particularly, the wrap sheet may be supplied from the upstream side and taken up at the downstream side so as to improve an appearance of a finished surface of a product. The rollers 8a, 8b, 8c and 8d and the wrap sheet 8e constitute a separating means 8 for separating the wrap sheet 8e that is another or an upper separating sheet in the first embodiment.

The first embodiment has been described as an example in which the Teflon belt 6c of the belt conveyor 6 is covered or coated with the wrap sheet composed of the wrap film or the heat-resistant sheet or the like. However, a structure similar to the separating means 8 may be used as a separate structure from the belt conveyor 6.

[Microwave Heating Unit]

The microwave heating unit 20 is arranged between the roller 8c and the roller 8d that are located at a downside of the separating means 8. In the microwave heating unit 20, the microwave generator 21 outputs microwaves of a frequency within a range of 300 MHz to 300 GHz. The microwaves are radiated particularly on the plant fiber fibrils 1 in the fiber mixture material 3 so as to heat the plant fiber fibrils 1.

[Heat-Compression Unit]

After the fiber mixture material 3 is heated by the microwave heating unit 20, it is compressed by the pressure plate 32 that is connected to a compression device 31 composed of a hydraulic cylinder or the like. Specifically, the plat fiber fibrils 1 in the fiber mixture material 3 generate the internal heat so as to solubilize the lignin contained therein. Then, the fiber mixture material 3 is compressed to join the plant fiber fibrils 1 with the thermoplastic fiber fibrils 2. At the same time, the heated pressure plate 32 heats the fiber mixture material 3 by compression of the fiber mixture material 3. The pressure plate 32 has a hydraulic cylinder structure that repeats a vertical motion together with the microwave generator 21. The pressure plate 32 constitutes the heat-compression unit 30. In the first embodiment, the microwave heating unit 20 and the heat-compression unit 30 have a common structure.

The fiber mixture material 3 is irradiated with the microwaves of 300 MHz to 300 GHz in the microwave heating unit 20 while being covered with the separating means 8. Then, the internal temperature of the plant fiber fibrils 1 rises up to about 280° C. as desired, so that the lignin contained therein is solubilized by the internal heat generation of the plant fiber fibrils 1. Thereafter, the fiber mixture material 3 is compressed so that the plant fiber fibrils 1 are joined with the thermoplastic fiber fibrils 2. At the same time, the temperature of the plastic fiber fibrils 2 contained or stuck in the fiber mixture material 3 rises indirectly by the temperature rise of the plant fiber fibrils 1. It is possible to raise the temperature up to 280° C. at a center of the fiber mixture material 3 that requires the plastic fiber fibrils 2 to be melted. Therefore, in the first embodiment, it is possible to ensure the internal temperature in the plant fiber fibrils 1 to rise by the microwaves. Moreover, it is possible to remove moisture in the plant fiber fibrils 1 before compression.

Only with a conventional external heating such as a far-infrared heating or a hot-air heating, it is impossible to remove sufficiently the moisture contained in the plant fiber fibrils 1. Then, there may take place a phreatic explosion or at the time of heat-compression molding. In contrast, according to the first embodiment, it is possible to set an evaporation amount at a desired value such that the moisture content in the plant fiber fibrils 1 after heating becomes 5% or less.

The microwave heating unit 20 adopts a technique that the microwave generator 21 outputs the microwaves of the frequency of 300 MHz to 300 GHz via a waveguide for heating in the microwave heating unit 20. However, such technique is a well-known microwave heating technique, so description thereof is omitted.

[Separating Means]

After heating by the irradiation of the microwaves in the microwave heating unit 20 and compressing by the heat-compression unit 30, the mixture material 3A is fed to the cool-compression unit 40 by the belt conveyor 6 via a relaying portion 9.

The cool-compression unit 40 has a belt conveyor 44 has A separating sheet such as a wrap film or a heat-resistant sheet is coated on a Teflon belt 44e of the belt conveyor 44 at a side of the mixture material 3 that the belt conveyor 44 conveys. Alternatively, the belt 44e is made of a material that is hard to be heated by the microwaves such as the Teflon belt or the like in the first embodiment. The Teflon belt 44e is rotated by four rollers 44a, 44b, 44c and 44d . Therefore, one or more of the four rollers 44a, 44b, 44c and 44d constitute one or more drive rollers. In the first embodiment, the Teflon belt 44e enables separation of the mixture material 3 in a softened state.

The Teflon belt 44e of the belt conveyor 44 in the cool-compression unit 40 may be substituted with a normal conveyor belt and an individual wrap sheet that is provided separately from the conveyor belt. Then, the wrap sheet is supplied from one side or an upstream side and taken up at another side. The rollers 44a, 44b, 44c and 44d and the Teflon belt 44e constitute the belt conveyor 44 of the first embodiment. The Teflon belt 44e is capable of separating the mixture material 3A in the softened state and constitutes a lower separating means 44A.

A wrap sheet 45e is provided at an upper side of the rollers 44c and 44d of the belt conveyor 44 so as to face the rollers 44c and 44d. The wrap sheet 45e is made of a hear-resistant sheet or the like and covers the mixture material 3a on an upper surface of the belt conveyor 44. The wrap roller 45e is rotated by four rollers 45a, 45b, 45c and 45d except an auxiliary roller. Therefore, one or more of the four rollers 45a, 45b, 45c and 45d constitute one or more drive rollers. The wrap sheet 45e may be structured such that it is supplied from the heat-compression unit 30 as an upstream side and taken up at another side. The rollers 45a, 45b, 45c and 45 and the wrap sheet 45e constitute an upper separating means 45 in the first embodiment.

[Cool-Compression Unit]

Two cool-compression devices 45A and 45B are disposed between the roller 45c and the roller 45d that are located at a lower side of the separating means 45. The cool-compression device 45A and the cool-compression device 45B are capable of vertically moving a metal pressure plate 42a and a metal pressure plate 42b, respectively, by a hydraulic cylinder 41a and a hydraulic cylinder 41b. A fixed metal pressure plate 43a and a fixed metal pressure plate 43b are arranged between the roller 44c and the roller 44d of the belt conveyor 44 so as to correspond to the pressure plate 42a and the pressure plate 42b, respectively. Water cooling pipe conduits (not shown) are disposed on the pressure plate 42a, the pressure plate 42b, the pressure plate 43a and the pressure plate 43b, respectively.

The mixture material 3A is sent from the heat-compression unit 30 to the cool-compression unit 40 by the belt conveyor 44. The belt of the belt conveyor 44 is normally made of such a material such as a stainless belt or a Teflon belt in view of durability, heat-resistance, separating or peeling property or the like. In order to enhance productivity, it is preferable that the mixture material 3A sent from the microwave heating unit 20 and the heat-compression unit 30 is conveyed to the upper surface of another conveyor such as a stainless conveyor, namely, the belt conveyor 44, thereby to be fed to the cool-compression unit 40. In the hot-compression unit 30 and the cool-compression unit 40, the mixture material 3A is preferably transported from one step to another step while being always held between the upper and lower pair of the separating means.

[Attenuating Device of Microwave Heating Unit]

The fiber mixture material 3 is continuously supplied to the microwave heating unit 20, while being stacked on the upper surface of the belt conveyor 6. At this time, as shown in FIG. 3, an attenuating device 23 of a window shape is installed at each of an entrance and an exit of the microwave heating unit 20. The attenuating device 23 serves to block the microwaves radiated inside the microwave heating unit 20 from leaking from a gap or a clearance between an oven wall 22 and the upper surface of the belt conveyor 6. The microwave attenuating devices 23 are provided respectively at the entrance and the exit of the oven wall 22 of the microwave heating unit 20 in proximity to the mixture material 3A. The attenuating device 23 has a shape protruded and extended in a longitudinal direction so as to sufficiently attenuate the microwaves. Microwave absorbing materials 24 are disposed inside the attenuating device 23 so as to lessen the microwaves that are released to an outside of a microwave oven or the microwave heating unit 20. Thus, though the microwaves are generated successively in the microwave heating unit 20, they are prevented from releasing to the outside of the microwave heating unit 20 by the attenuating device 23 and the microwave absorbing materials 24 that are in vicinity of the mixture material 3A.

[Cutting Unit]

The mixture material 3A is conveyed to a cutting unit 50 after the density of the plant fiber fibrils 1 and the thermoplastic fiber fibrils 2 becomes high by cool-compression in the cool-compression unit 40. That is, the mixture material 3A is fed and sent to the cutting unit 50 for cutting or the like sent by a belt conveyor 51. The belt conveyor 51 is composed of a drive roller 51a, a driven roller 51b and a belt 51c spans them in a rotatable way. The belt conveyor 51 may be a well-known belt conveyor. In the first embodiment, a feeding roller 52a and a feeding roller 52b are further arranged so as to make feeding operation easy and facilitate a cutting work at the cutting unit 50.

In case of manufacturing a plastic fiber board as a plastic fiber molding 3B, the cutting unit 50 can remove burr or the like at an end part of a product so as to line up standardized plastic fiber boards as required. The end parts of the product as a waste material may be finely pulverized and fibrillated. In this case, the end parts can be compressed and molded in a certain shape for another use. Conventionally, a chipboard or a fiber board or the like using a thermosetting resin such as phenol plastic, melamine plastic or urea plastic needs to be added with an adhesive, each time it undergoes a heat compression molding. However, the first embodiment of the molding can be pulverized and molded as many times as needed by heat-compression by utilizing the thermoplastic resin as an adhesive. Thus, it was confirmed that the first embodiment is helpful enough for effective use of resources.

A manufacturing process of the plastic fiber molding 3B is described hereafter.

First, the fiber mixture material 3 is stacked on the upper surface of the belt conveyor 6 in low density. Then, the fiber mixture material 3 is sent into the microwave heating unit 20. The plant fiber fibrils 1 of the fiber mixture material 3 are heated to a predetermined temperature by the microwaves in the microwave heating unit 20. Then, each of the fibers becomes a softened or melted state. The plant fiber fibrils 1 are composed of macromolecular components such as cellulose, hemicellulose, lignin and so on. The cellulose exists as a linear macromolecule (C6H10O5)n in all plant bodies. The cellulose has no glass transit point or melt point. The cellulose lies between plant fiber elements. The lignin substance exists as a macromolecule composed of a phenylpropane unit in a plant fiber material. The lignin substance has no repeat unit and lies as an aromatic natural polymer having a hydroxyl group between plant fiber elements. The lignin substance having the hydroxyl group is easy to react with heat or an organic solvent or the like and lies as a very instable substance between the plant fiber fibrils 1.

The lignin substance is a substance having a strong adhesiveness as well known. Conventionally, the lignin substance is separated or extracted by heating with a pressure plate or a chemical solution. However, in case of extracting or removing the lignin by an external heating method using the heated pressure plate, the lignin is seriously degraded or carbonized. Thus, the lignin cannot perform its intrinsic strong adhesiveness. In contrast, in the first embodiment, the plant fiber material is pulverized or fibrillated into the fine plant fiber fibrils 1. Moreover, the plant fiber fibrils 1 are preferably impregnated with about 5% to 30% of moisture. Therefore, the plant fiber fibrils 1 are heated in the microwave heating unit 20 by the high frequency microwaves having the frequency of 300 MHz to 300 GHz.

The water molecules impregnated in the plant fiber fibrils 1 polarizes between nucleus of the plant fiber fibrils 1 by heating by the microwaves, thereby generating heat of about 40° C. to 280° C. from the inside. In this case, frictional heat is generated by the microwaves between the macromolecular components such as the cellulose, hemicellulose or lignin. Then, the lignin and the hemicellulose are hydrolyzed so as to be solubilized, while part of them changing into oligosaccharide. Thereafter the hemicellulose and the lignin and so on are solubilized in the plant fiber fibrils 1. Since the plant fiber fibrils 1 are required to be compressed rapidly, the lignin component can be squeezed out from the plant fiber fibrils 1 themselves. The lignin substance hydrolyzed by the microwave heating is separated or extracted in a state having strong adhesiveness without degradation or oxidization. Specifically, a pressure of about 35 kg/cm2 is applied for compression to the entire fiber mixture material 3 after the irradiation of the microwaves. Consequently, the lignin substance can be extracted from the plant fiber fibrils 1 without degradation or oxidization. At this time, a chemical reaction formula of the lignin and a polyethylene is represented as shown in FIG. 5, for example.

Specifically, as a basic experiment, a hinoki (Japanese cypress) was repeatedly pulverized and fibrillated into the plant fiber fibrils 1 of 200 g. Then, the plant fiber fibrils 1 were irradiated with microwaves of 2450 MHz at a power of 5 kw for 5 minutes. Thereafter, the plant fiber fibrils 1 were compressed instantaneously by a pressure of 35 kg/cm2, thereby extracting 3.5 grams of lignin substance in a state of solution without degradation. The extracted lignin was neither degraded nor carbonized and ensures a fluidity having a viscocity coefficient of 53.21 Moas/37.8° C. Thus, its chemical bond with the plastic fiber fibrils 2 was confirmed. The plant fiber fibrils 1 were facilitated to hydrolyze from inside by the microwave heating of the frequency of 300 MHz to 300 GHz, so that the lignin underwent solubilization so as to change into instable molecular structure. Thereafter, the lignin substance was extracted from the plant fiber fibrils 1. At this time, in the lignin substance extracted or separated by the pressure, its benzene nucleus or β-ether bond was free from separation or cleavage, so that the lignin substance had no degradation while having a strong welding property.

Lignin substance extracted by the external heating such as the far infrared heating or the pressure plate heating generates an oxidization or degradation phenomenon. In contrast, the lignin substance heated by the microwaves exists as an aromatic natural macromolecule having the hydroxyl group. Consequently, the macromolecule or polymer composed of the thermoplastic resin undergoes condensation or bond with the hydroxyl group. As a result, the plastic fiber fibrils 2 and the plant fiber fibrils 1 can be bonded or partially integrated.

While the interrelated fiber fibrils of the plastic fiber fibrils 2 and the plat fiber fibrils 1 are entangled into a low density mixture or a mixed state in the fiber mixture material 3, the fiber mixture material 3 is heated from a center layer portion by microwaves. Then, the fiber mixture material 3 is changed into a softened and melted state. That is, the lignin is solubilized by an internal heat generation of the plant fiber fibrils 1. The lignin is then applied with a pressure by compression so as to be extracted as a lignin in a state of solution. The plastic fiber fibrils 2 that are intertwined or stuck as the interrelated fiber fibrils are to contact with the extracted lignin. The plastic fiber fibrils 2 are heated indirectly by the heat generation of the plant fiber fibrils 1. The plastic fiber fibrils 2 as a component of the fiber mixture material 3 is softened by such indirect heating and changed into a softened state. Specifically, if a pressure of about 35 kg/cm2 is applied rapidly to the fiber mixture material 3 in the solubilized state that has a low density of 0.4 kg/cm3 or less, the interrelated fiber fibrils in the entangled state are welded with other so as to be integrated. At this time, a friction heat is generated between the interrelated fiber fibrils in the entangled state, so that melting of the plastic fiber fibrils 2 in the melted state progressed more.

In the present embodiment, the plant fiber fibrils 1 are heated by the microwaves after a given amount of water is contained therein, so that the fiber mixture material 3 is capable of increasing a temperature from the center portion. The felt-like fiber mixture material 3 supplied into the microwave heating unit 20 have the upper and lower sides covered by the separating means, so that an efficiency in a temperature rise is made possible. In addition, it is more effective to perform the external heating with a infrared radiation, a heated air, a pressure plate or the like in conjunction with the microwave heating.

[Side Plate]

In the heat-compression unit 30, the heated plat fiber fibrils 1 are compressed by the heated pressure plate 32 and the pressure plate 33. It means that a rapid compression force is applied to the fiber mixture material 3 in a low density state and in a softened or melted state. Then, the fiber mixture material 3 is pushed by the compression force so as to be protruded in a width direction. Therefore, as shown in FIG. 4, side plates 9 are provided between the upper and lower pair of the pressure plate 32 and the pressure plate 33 so as to extend in a direction perpendicular to a vertical direction or in a horizontal direction in the present embodiment. Thus, the side plates 9 regulate or prevent such protrusion in the width direction, thereby forming the mixture material 3A that ensures a uniform density.

In the cool-compression unit 40, the mixture material 3A is compressed between the metal pressure plates 42a and 42b and the metal pressure plates 43a and 43b. It also means that a compression force is applied to the mixture material 3A in a softened state. Then, the mixture material 3A is pushed by the compression force and sometimes protruded in a width direction. Therefore, side plates (not shown) are provided between the upper and lower pair of the pressure plate 32 and the pressure plate 33 and between the metal pressure plates 42a and 42b and the metal pressure plates 43a and 43b of the cool-compression unit 40 so as to extend in a direction perpendicular to a vertical direction or in a horizontal direction in the present embodiment. Thus, the side plates regulate or prevent such protrusion in the width direction, thereby forming the mixture material 3A that ensures a uniform density.

In the present embodiment, a uniform plastic fiber molding can be manufactured by compression heating, while it is held between the side plates 9 and the upper and lower pair of the pressure plate 32 and the pressure plate 33 and between the metal pressure plates 42a and 42b and the pressure plates 43a and 43b of the cool-compression unit 40 and the side plates not shown, in a space defined between the side plates 9 extending in the direction perpendicular to the vertical direction in FIG. 4 and the upper and lower pair of the pressure plate 32 and the pressure plate 33 and between the metal pressure plates 42a and 42b and the pressure plates 43a and 43b of the cool-compression unit 40 and the side plates now shown.

That is, the mixture material 3A in the softened and melted state is protruded in the width direction in the heat-compression unit 30 where the mixture material is heated and compressed. Therefore, the mixture material 3A can be always regulated from moving in the width direction by disposing the side plates 9 at clearances between the upper and lower belts that are integrally used. Moreover, there are provided an upper and lower pair of the separating means composed of the separating means 8 having the wrap sheet 8e and the belt conveyor 6. Furthermore, there are provided an upper and lower pair of the separating means composed of the separating means 45 having the wrap sheet 45e and the belt conveyor 44. In addition, the right and left side plates 9 are provided at clearances of the upper and lower pair of the separating means composed of the separating means 8 and the belt conveyor 6 so as to regulate the protrusion in the width direction of the mixture material 3A. Thus, the mixture material 3 is prevented from protrusion at the time of compression molding, thereby being kept in a uniform density.

As described above, after the plant fiber fibrils 1 are softened and solubilized by the microwaves, the mixture material 3 is instantaneously heated with the heating of about 40° C. to 280° C. in the heat-compression unit 30 and the heating of the pressure plates, while being compressed with the compression force of about 10 kg/cm2 to 60 kg/cm2, whereas the mixture material 3 is sandwiched between the upper and lower integral pair of the separating means. The softened and melted fiber mixture material 3 becomes the mixture material 3A having a high density. Then, the mixture material 3A is fed rapidly to the cool-compression unit 40, while being sandwiched between the upper and lower integral pair of the separating means. The mixture material 3A having a predetermined bulk size goes through the compression molding actions in series each time it is fed to the microwave heating unit 20, the heat-compression unit 30 and the cool-compression unit 40. Particularly, the mixture material 3A having a predetermined bulk size goes through the compression molding actions repeatedly.

The mixture material 3A melted and integrated in the heat-compression unit 30 moves to the cool-compression unit 40 in a short period of time, while being held between the upper and lower pair of the separating means. The mixture is required to move at once from the heat-compression unit 30 to the cool-compression unit 40 in order to prevent degradation or oxidization of the plastic. It is preferable to move, cool rapidly and solidify the mixture material 3A within about three minutes. The cool-compression unit 40 has the metal pressure plate 42a and 42b and the metal pressure plates 43a and 43b at the upper and lower sides that are cooled at a temperature of about 10° C. to 180° C. They hold the melted mixture material 3A as a whole therebetween so as to cool and compress it. The metal pressure plates 42a and 42b and the pressure plates 43a and 43b hold the mixture material 3A as a whole or in part therebetween and planarly compress the mixture material 3A at a pressure of about 25 kg/cm2 to 70 kg/cm2. Thus, the mixture material 3A is restrained from generating heat distortion and cooled so as to be changed into a solidified state in a short period of time. The mixture material 3A that is melted and integrated in the heat-compression unit 30 as well as in the microwave heating, is solidified by the cooling and the further compressing. Thereby, the plastic fiber molding 3B is capable of ensuring the physical strength. After building up such structure of the strong plastic fiber molding 3B, the mixture material 3B is fed out of the cool-compression unit 40. At the time of feeding out, the upper and lower pair of the Teflon belt 44e and the wrap sheet 45e that is stuck or plastered to the plastic fiber molding 3B is taken up by the separating means 45 and the belt conveyor 44. The plastic fiber molding 3B is cut and separated by the cutting blade of the cutting unit 50 that is rotated at a high speed. Thus, a desired plastic fiber board can be obtained.

The fiber mixture material 3 is supplied continuously to the microwave heating unit 20, while being stacked on the upper surface of the belt conveyor 6. At this time, as shown in FIG. 3, the attenuating device 23 is installed at the entrance and the exit of the microwave heating unit 20 so as to prevent the microwaves radiated inside the microwave heating unit 20 from leaking to an outside of the oven wall 22. The microwave attenuating devices 23 are provided respectively at the entrance and the exit of the oven wall 22 of the microwave heating unit 20 in proximity to the mixture material 3A. The attenuating device 23 has the shape protruded and extended in the longitudinal direction so as to sufficiently attenuate the microwaves. The microwave absorbing materials 24 are disposed inside the attenuating device 23 so as to lessen the microwaves that are released to the outside of the microwave oven. Thus, though the microwaves are generated successively in the microwave heating unit 20, they are prevented from releasing to the outside of the microwave heating unit 20 by the attenuating device 23 and the microwave absorbing materials 24 that are in the vicinity of the mixture material 3A.

### FIRST EXAMPLE

First, plant fiber fibrils 1 are made by finely pulverizing and fibrillating a plant fiber material such as the wood chips or the waste paper as a row material. The plant fiber fibrils 1 are composed of the macromolecular components such as the cellulose, the hemi-cellulose and the lignin. The lignin is extracted from the plant fiber fibrils 1 by the dielectric action of the microwaves, while the cellulose component existing therebetween as a residue heightens absorption of an aggregation energy as the plastic.

Specifically, broken woods of houses or the like were finely and repeatedly pulverized and fibrillated so as to make the plant fiber fibrils 1 of a fiber diameter of about 0.3 mm and a fiber length of about 15 mm. A moisture content of the plant fiber fibrils 1 varies according to a weather or circumstances or the like. However, in the present embodiment, the moisture content was controlled to 5% or more. In detail, in the present embodiment, water was further absorbed into the finely fibrillated plant fiber fibrils 1 so as to heighten the moisture content up to 20%. According to an experiment of the inventor, it is not preferable to heighten the moisture content to a value more than 20%, since a heating efficiency is lowered and it is more possible that water vapor is closed in the plastic fiber molding.

PP (polypropylene), PE (polyethylene), PVC (polyvinyl chloride), ABS plastic, PS (polystyrene), PET plastic, nylon, PA (polyamide) or other thermoplastic resin may be used as a thermoplastic resin that constitutes a base material. If a thermoplastic resin having a melting temperature of 260° C. or less exists in an amount of about ⅕ of the total mass, it is possible to mix a thermosetting resin such as PU (polyurethane), urea plastic, melamine plastic or phenol plastic.

In the present example, the thermoplastic resin such as PP (polypropylene), PE (polyethylene) or PVC (polyvinyl chloride) that is a container or packaging plastic for home use, was once melt-spinned so as to make fine plastic fiber fibrils 2. At this time, the plastic fiber fibrils 2 went under the melt-spinning so that plastic fiber fibrils 2 having a fiber diameter of 0.01 to 2.0 mm were obtained. Then, the plastic fiber fibrils 2 went under repeated pulverization and cutting so that plastic fiber fibrils 2 having a fiber length of about 10 mm to 30 mm were obtained from the waste container or packaging plastic for home use. The plant fiber fibrils 1 were mixed in a proportion of 40% of the total mass, while the plastic fiber fibrils 2 were mixed in a proportion of 60% of the total mass. Then, the interrelated fiber fibrils were stirred and mixed so as to obtain a fiber mixture material 3 in which the interrelated fiber fibrils exist as a mixture while intertwined. At the time of stirring and mixing the interrelated fiber fibrils of the plant fiber fibrils 1 and the plastic fiber fibrils 2, additional water was further sprayed and added so as to heighten a percentage of the water contained in the plant fiber fibrils 1 up to about 20%.

The fiber mixture material 3 of a fixed amount or ratio was put in from the hopper 4 and stacked uniformly on the upper surface of the rotating belt conveyor 6. The fiber mixture material 3 stacked in the fixed amount was swept by a rotating brush 6 (not shown) so as to be trimmed to an even bulk size or height, thereby being fed to the microwave heating unit 20 via the belt conveyor 6. At this time, the bulk size or height of the fiber mixture material 3 on the upper surface of the belt conveyor 6 is 80 mm and the density thereof is 0.12 kg/cm3. The plant fiber fibrils 1 are contained in the ratio of 40% of the total mass, while the plastic fiber fibrils 2 are contained in the ratio of 60% of the total mass.

The fiber mixture material 3 is stacked on the belt conveyor 6 and fed to the inside of the microwave heating unit 20 while held between the conveyor belt 6 and the separating means 8. At this time, metal pieces of the like mixed in the fiber mixture material 3 pass through a foreign body removing device (not shown). Thus, the fiber mixture material is heated in the microwave heating unit 20 after the metal foreign bodies are removed. That is, it is necessary to remove the metal foreign bodies in order to provide a measure for fire by the microwaves or the like in advance so as to improve safety.

The fiber mixture material 3 was heated by the microwave heating unit 20. Then, the water contained in the plant fiber fibrils 1 were heated by the microwaves. Thus, the plant fiber fibrils 1 themselves became a heat generating body, so that the temperature rises from the inside of the fiber fibrils. At this time, the microwaves were radiated to heat the fiber mixture material 3 for five minutes at a frequency of 2450 MHz and an output of 25 Kw.

The conventional external heating system such as the infrared radiation heating or the hot air heating could raise the temperature only at a superficial part of the fiber mixture material 3. It could not raise the temperature at an inside or a core part of the fiber mixture material 3. Thus, it was difficult for the conventional system to manufacture a strong fiber board. However, it was confirmed that, if the external heating system such as the infrared radiation heating or the hot air heating was used in combination with the microwave heating as a basis, the productivity improved.

The fiber mixture material 3 in a low density state was fed quickly to the heat-compression unit 30 in order to give a rapid compressing action after it was heated by the microwaves to raise the temperature evenly up to about 200° C. from the core part thereof. The hot-compression unit 30 further carried out a compression and a heating of the fiber mixture material 3 with the upper and lower pair of the heated pressure plate 32 and the heated pressure plate 33. The upper and lower pair of the heated pressure plate 32 and the heated pressure plate 33 repeated rapid heating and compressing actions on the plant fiber fibrils 1 and the plastic fiber fibrils 2 that were in the low density state.

The fiber mixture material 3 of the bulk size of height of 80 mm and the density of 0.12 kg/cm3 was rapidly compressed into a mixture material of a bulk size or height of 13 mm and a density of 0.73/cm3 by the heating and compressing actions of the upper and lower pair of the heated pressure plate 32 and the heated pressure plate 33. At this time, the interrelated fiber fibrils of the plant fiber fibrils 1 and the plastic fiber fibrils 2 were in a state of uniformly entangled or stuck. Moreover, a rub or physical frictional heat was generated at contact surfaces of the interrelated fiber fibrils or among the interrelated fiber fibrils by the rapid compressing and heating of the fiber mixture material 3 of low density. Accordingly, the separating means were interposed between the mixture material 3A and the heated pressure plate 32 and the heated pressure plate 33 in the hot-compression unit 30. Moreover, the side plates 9 shown in FIG. 4 were disposed at both end portions thereof so as to prevent the mixture material 3A from laterally leaking.

The mixture material 3A heated and compressed by the heating of the microwaves and the heated pressure plate 32 and the pressure plate 33 was held in a melted state between the separating means provided on the belt conveyor 6 and the separating means 8, thereby being transferred swiftly to the cool-compression unit 40. Then, overall opposite surfaces of a molded body of the mixture material 3A were covered by the Teflon belt 44e of the belt conveyor 44 and the separating means 45 quickly from the state in which the plastic was softened and melted. Moreover, the molded body were cooled and compressed uniformly by the upper and lower pair of the metal pressure plates 42a and 42b and the pressure plates 43a and 43b of the cool-compression unit 40. Thus, a solidified plastic fiber molding 3B was obtained. Specifically, the entire softened and melted mixture material 3A was compressed from a thickness of 13 mm to a thickness of 12 mm at a cooling temperature of 35° C. in the cool-compression unit 40 so as to increase the density of the mixture material 3A. That is, the cooling and compressing action of the cool-compression unit 40 was carried out at the cooling temperature of 35° C. for five minutes as a cooling time and at a pressing force of 45 kg/cm2 so as to make the bulk size or height to 12 mm, thereby providing a plastic fiber body 3B of a specific gravity of 0.8 kg/cm3.

In embodying the invention, if the heat-compression unit 30 and the cool-compression unit 40 were respectively separated in to plural steps, the productivity is improved more.

After obtaining the plastic fiber molding 3B of the thickness of 12 mm by the cool-compression unit 40, the plastic fiber molding 3B moved from a state in which it was held between the upper and lower pair of the Teflon belt 44e of the belt conveyor 44 and the wrap sheet 45e having the Teflon sheet of the separating means 45 to a state in which it was separated therefrom. Then, the plastic fiber molding 3B was delivered to the cutting unit 50.

The plastic fiber molding 3B was cut into a desired size at its opposite end portions and in a longitudinal direction, thereby separated into a specific size of plastic molded board.

The plastic fiber molding 3B of 12 mm thick obtained by the heating of the microwaves and the cool-compression unit 40 could improve a bending strength by 35% in comparison with a conventional fiber board.

A comparison example of the plastic fiber molded board is shown in the following table.

TABLE 1

| | Fiber board | | |
|---|---|---|---|
| | Veneer | Exterior | Microwave |
| | Plywood | Heating | Heating |
| Specific Gravity | 0.57 | 0.8 | 0.8 |
| Bending Strength | 225 kgf/cm2 | 125 kgf/cm2 | 235 kgf/cm2 |
| Water-Absorbing | 17.9% | 4.7% | 1.6% |
| Property | | | |
| Formaldehyde | 0.19 mg/l | 0.01 mg/l | 0.01 mg/l |
| Emission | or less | or less | or less |
| Interior | | 130° C. | Temperature rise |
| Temperature in | | | only in plant |
| Heating | | | fiber fibrils |

As shown above, the plastic fiber molding 3B of the present embodiment of the invention is found that it has a high bending strength, low water-absorbing property and low formaldehyde emission and that it is a material superior to the veneer plywood.

The present embodiment of the invention used a metal mold or die for shaping a board material at the microwave heating unit 20, the heat-compression unit 30 and the cool-compression unit 40. However, it was confirmed that it can sufficiently shape a curved surface such as an automobile interior material or a furniture frame by use of a proper shaping mold or die.

### Second Embodiment

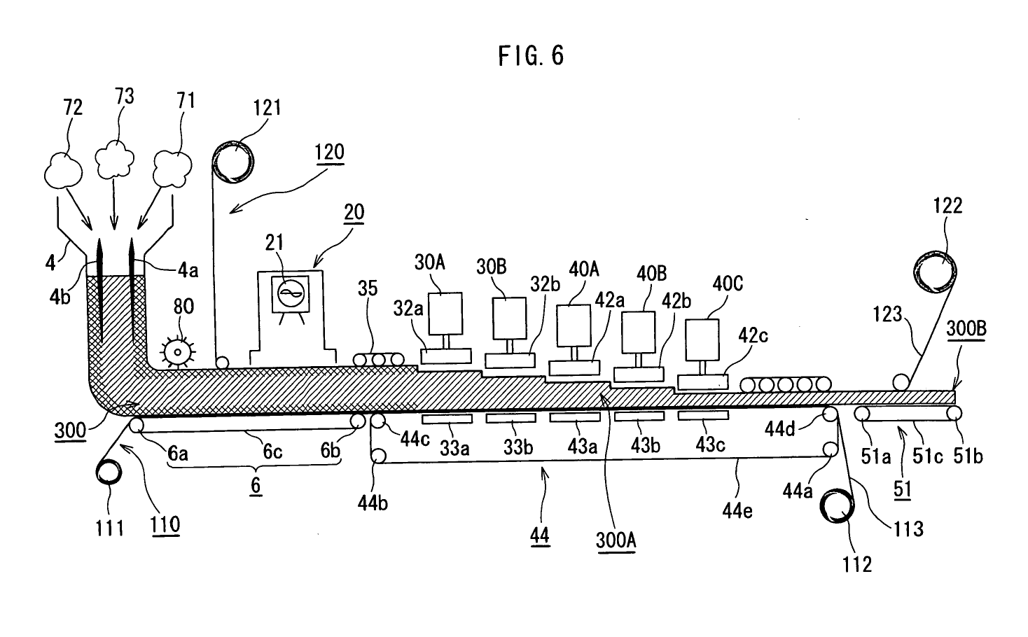

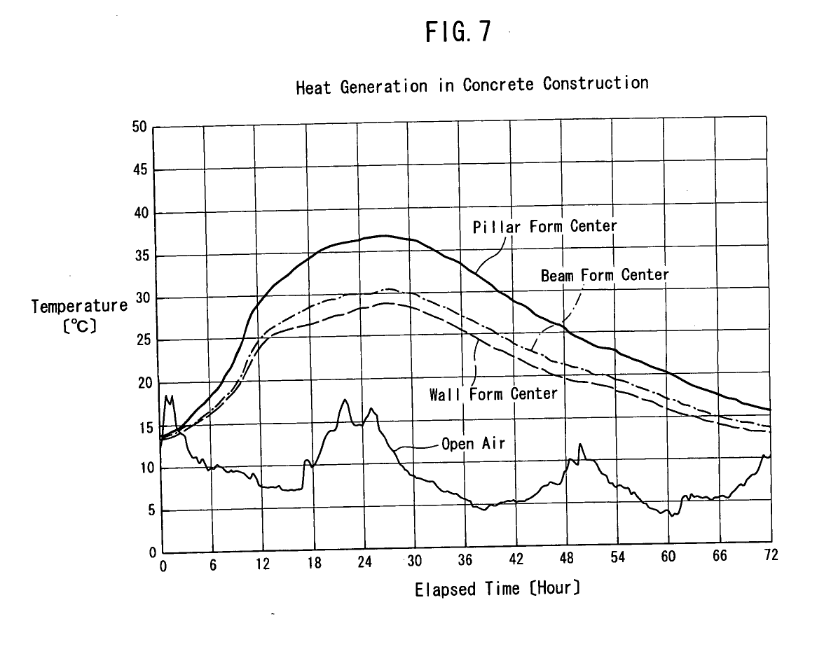

FIG. 6 is a schematic view of an overall system for a manufacturing method of a plastic fiber molding according to a second embodiment of the invention. Described in the present embodiment is a manufacturing method of a plastic fiber molded board used as a building material. In the drawing, the same codes and the same characters as those of the first embodiment show respectively the same or corresponding parts and a redundant description will be omitted. The present embodiment will be described while being put emphasis on features different from those of the first embodiment. Features not described hereafter do not differ basically from those of the first embodiment.

Described in the present embodiment is a manufacturing of a plastic fiber molded board of a thickness of about 4 mm and a specific gravity of about 0.6 that is used as a construction material.

Used as a raw material were plant fiber fibrils 1 obtained by finely pulverizing thinned woods such as the Japanese cypress into a fiber diameter of about 0.3 mm to 1.0 mm and a fiber length of about 15 mm to 30 mm and plastic fiber fibrils 2 made of waste plastic materials composed of vinyl or plastic sheets for container and packaging and plastics of home electronic appliances. The plastic sheets were made into thin strip pieces by repeatedly pulverizing and cutting a previously expanded thin plastic sheet into thin band shape or cord shape of a thickness of about 0.1 to 0.3 mm, a width of about 1 to 5 mm and a length of about 10 to 30 mm. The plastics of home electronic appliances were melt-spinned. Thus, the plastic fiber fibrils 2 of a fiber diameter of about 0.1 to 0.8 mm and a fiber length of about 5 to 30 mm were obtained. The plant fiber fibrils 1 and the plastic fiber fibrils 2 were stirred and mixed, thereby becoming a fiber mixture material 3 in which the plant fiber fibrils 1 and the plastic fiber fibrils 2 were entangled and stuck with each other.

Specifically, a plastic fiber board is made into a layered structure composed of three layers of a front layer 71, a rear layer 72 and a center layer 73 in order to improving weight saving and uniformizing of surface layers.

As the front layer 71 and the rear layer 73 constituting surface layers of a fiber mixture material 300, the plant fiber fibrils 1 and the plastic fiber fibrils 2 were supplied respectively from input openings of a hopper 4, while evenly stirring and mixing them at a mixing ratio of 10% of the plant fiber fibrils 1 and 90% of the plastic fiber fibrils 2. Water was added so as to make a moisture content of the plant fiber fibrils 1 to 10% when stirring and mixing the plant fiber fibrils 1 and the plastic fiber fibrils 2. As the center layer 72 constituting a core part of the fiber mixture material 300, the plant fiber fibrils 1 and the plastic fiber fibrils 2 were supplied from an input opening of the hopper 4 as in the front layer 71, while evenly stirring and mixing them at a mixing ratio of 70% of the plant fiber fibrils 1 and 30% of the plastic fiber fibrils 2.

While the fiber mixture material 300 for the front layer 71, the rear layer 72 and the center layer 73 is supplied respectively or separately from the input openings of the hopper 4, a partition plate 4a and a partition plate 4b are provided on the input opening for the front layer 71 and the input opening for the center layer 73 so as to make a uniform layered structure and separate the layers respectively. The partition plate 4a and the partition plate 4b end in the middle of an input path. They are set such that the fiber mixture material 300 is made into three layers when supplied from the input opening and passing through the input path.

The fiber mixture material 300 composed of the front layer 71, the rear layer 72 and the center layer 73 supplied from the hopper 4 was fed on an upper surface side of a belt conveyor, thereby making a uniform felt-like layered structure. The fiber mixture material 300 is stacked evenly on the upper surface side of the moving belt conveyor 6 in a bulk size or height of 200 mm and a specific gravity of 0.12 kg/cm3. A surface of the layered material 300 is swept by a rotating brush 80 disposed at the upper surface side for trimming the bulk size or height so as to make the bulk size or height constant.

A separating sheet 113 is disposed on upper surfaces of the belt conveyor 6 and a belt conveyor 44 along their full length. The separating sheet 113 is made of a wrap film or a heat-resistant sheet or the like that is supplied from a supply roller 112 and taken up by a take-up roller 112. The supply roller 111, the take-up roller 112 and the separating sheet 113 constitute a separating means 110 of the present embodiment. A separating sheet 123 is disposed on an upper surface of the fiber mixture material 300 at the upper surface side of the belt conveyor 6 and on an upper surface along its full length of a mixture material 300A at the upper surface side of the belt conveyor 44. The separating sheet 123 is made of a wrap film or a heat-resistant sheet or the like that is supplied from a supply roller 121 and taken up by a take-up roller 122. The supply roller 121, the take-up roller 122 and the separating sheet 123 constitute a separating means 120 of the present embodiment.

The fiber mixture material 300 stacked on the upper surface side of the belt conveyor 6 was transferred inside a microwave heating unit 20 and heated by microwaves for about 10 minutes at a frequency of 2450 MHz and an output of 50 kw.

In the first embodiment, the fiber mixture material 3 was held between the separating sheets such as the wrap sheet or the Teflon sheet. In contrast, the second embodiment is capable of heightening more a heat generating efficiency by the microwave radiation by making the fiber mixture material in the three layered structure of the front layer 71, the rear layer 72 and the center layer 73, in addition to the separating means 110 and the separating means 120. The mixture material 300A had its internal temperature rise uniformly to about 230° C. by the microwave heating. Then, the mixture material 300A was fed quickly to a heat-compression unit 30 or heat compression units 30A and 30B. The fiber mixture material 300 that raised the internal temperature by the microwave heating may be preheated by an external heating such as an infrared radiation heating or a hot air as desired. Moreover, the fiber mixture material 300 may be preliminarily compressed so as to have a bulk size or height of 120 mm in advance, as desired.

The heated mixture material 300A was heated by an adjacent preheat roller 35 and thermally controlled so that the temperature of the mixture material 300A did not decline before compression molding at the heat-compression units 30A and 30B. The mixture material 300A that had its temperature controlled and its bulk size or height trimmed sufficiently was transferred to the heat-compression units 30A and 30B so as to be compressed and molded. Specifically, it was heated and compressed by an upper and lower pair of heated pressure plates 32a, 33a, 3b, 33b. In this case, the pressure plates 32a, 33a, 32b, 33b rapidly compressed the mixture material 300A at a temperature of 230° C., at a pressure of 35 kg/cm2, in a pressing time of 10 minutes and at a compressing speed of 150 mm/sec, thereby making the bulk size or height from 120 mm to 41 mm. Thus, the lignin of the mixture material 300A was extracted and the specific gravity thereof became 0.65.

At the heat-compression unit 30 or the heat compression units 30A and 30B, side plates 9 were disposed for preventing the mixture material 300A from laterally extruding or protruding, while the heated pressure plates 32a, 33a, 32b, 33b were divided, thereby realizing improvement of productivity and deaeration of vapor by repeating compression. The plant fiber fibrils 1 solubilized by the microwaves were softened and melted, while having the lignin squeezed out and extracted, when compressed at the heat-compression unit 30 or the heat compression units 30A and 30B. As mentioned above, the fiber mixture material 300A of a low density made of the plant fiber fibrils 1 and the thermoplastic resin fiber fibrils 2 was heated by the microwaves so that the fiber mixture material 300A was made into a softened state. Then, the fiber mixture material 300A was compressed so that the lignin squeezed out from the plant fiber fibrils 1 and adjacent parts of the thermoplastic resin fiber fibrils 2 were melted and integrated. Thereby, the melted and integrated mixture material 300A was fed quickly to a cool-compression unit 40, while being held between the upper and lower integral pair of the separating means.

The cool-compression unit 40 has three cool-compression devices 40A, 40B and 40C, while dividing pressure plates into three, namely, pressure plates 42a, 42b and 42c and pressure plates 43a, 43b and 43c, thereby shortening a cooling time and improving productivity. In such separate cooling and compressing actions, the mixture material 300A was further compressed and cooled and solidified by the upper and lower pair of the pressure plates 42a, 42b, 42c and the pressure plates 43a, 43b, 43c of the three cool-compression devices 40A, 40B and 40C. The upper and lower pair of the pressure plates 42a, 42b, 42c and the pressure plates 43a, 43b, 43c performed such solidifying action at a temperature of 15° C., at a pressure of 45 kg/cm2 and in a cooling time of 15 minutes. Thus, a plastic fiber board 300B of a thickness of 40 mm and a specific gravity of 0.6 was molded or shaped.

Thereafter, the separating sheet 113 of the separating means 110 and the separating sheet 123 of the separating means 120 stuck to the mixture material 300A were separated by a take-up action of the take-up roller 112 and the take-up roller 122. Then, a surplus material was cut off by a cutting blade (not shown) that rotated at a high speed, thereby finishing a building material of a thickness of 40 mm and a specific gravity of 0.6. In the building material using the thermoplastic resin, an amount of formaldehyde emission was 0.01 mg/l or less and the value did not go far enough for confirming a quantity of the formaldehyde emission. Thus, it was confirmed that it was effective as an environment-friendly building material.

As mentioned above, the present embodiment aims to effectively use the thermoplastic resin made of the waste plastics as an adhesive or a base material, against the thermosetting resin such as the urea plastic, the melamine plastic or the phenol plastic that is used as a conventional adhesive. Thus, it was confirmed that a new plastic fiber board 300B could be manufactured at low costs and without emission of formaldehyde.

An experiment was carried out to obtain test results on a concrete mold made by the plastic fiber board 300B as the plastic fiber molding according to the second embodiment that was formed as mentioned above.

First, a concrete was casted and a temperature change was checked until the concrete was solidified. Then, the result was as shown in a graph showing a heat generating property after concrete construction. That is, it is understood that it accompanies a temperature rise of about 20° C. until it is solidified.

In contrast, Table 2 shows coefficients of linear expansion in relation to temperatures of conventional concrete molds (a) to (d) and concrete molds using the plastic fiber board 300B according to the second embodiment of the invention.

TABLE 2
MATERIAL SR402 LINEAR EXPANSION COEFFICIENT OF MOLDING

| | Measured Temperature Range | | |
|---|---|---|---|
| Material | 50° C. to 70° C. | 70° C. to 90° C. | 90° C. to 110° C. |
| a) Veneer Plywood (Vertical) | | −7.255E−5 | |
| | | −6.175E−5 | |
| b) Veneer Plywood (Horizontal) | | −1.353E−5 | |
| | | −8.877E−5 | |
| c) Plastic Mold (Vertical) (PP) | 8.890E−5 | | 41.690E−5 |
| | 10.230E5 | | 61.830E−5 |
| d) Plastic Mold (Horizontal) (PP) | 15.160E−5 | | 39.870E−5 |
| | 16.390E−5 | | 67.490E−5 |
| e) Recycle Mold (Vertical) (Filler) | | −7.053E−5 | |
| Embodied Mold of Invention | | −2.113E−5 | |
| f) Recycle Mold (Horizontal) (Filler) | | −6.705E−5 | |
| Embodied Mold of Invention | | −3.888E−5 | |

As described above, while the plastic mold (c), (d) has relatively low coefficients of linear expansion in winter, it has relatively high coefficients of linear expansion in summer. That is, the linear expansion coefficient of the plastic mold (c), (d) increases in proportion to the temperature. Therefore, there is a problem that the plastic mold (c), (d) is hard to bear a pressure of the casted concrete. In contrast, the concrete mold (e), (f) using the plastic fiber board 300B according to the second embodiment has similar linear expansion coefficients to those of the concrete mold (a), (b) of the plywood. Thus, the concrete mold (e), (f) can be used for a hard concrete casting. Moreover, the concrete mold (e), (f) has higher bending strength, less water-absorbing property and less emission of formaldehyde in comparison with the plywood, as shown in TABLE 1. Thus, it is understood that the concrete mold (e), (f) is a material superior to the plywood.

According to one aspect of the above embodiment of the plastic fiber molding, the felt-like fiber mixture material 3 or fiber mixture material 300 made of the plant fiber fibrils 1 and the thermoplastic fiber fibrils 2 is heated by the microwaves so that the thermoplastic resin of the fiber mixture material 3 is softened. Particularly, the lignin contained in the plant fiber fibrils 1 is solubilized by the internal heat generation of the plant fiber fibrils 1 and squeezed out by the compression. Thus, the plant fiber fibrils 1 are joined partially to the plastic fiber fibrils 2, while the thermoplastic resin is entangled with the plant fibers and stuck on the surface of the plant fibers. Therefore, the fiber mixture material 3A or the mixture material 300A transformed from the fiber mixture material 3 or the mixture material 300 can be integrated firmly and rigidly. Moreover, the plastic fiber molding can be formed in a desired shape by the heat-compression unit 30 or the heat-compression unit 30A, 30B and the cool-compression unit 40 or the cool-compression unit 40a, 40B.

According to another aspect of the above embodiment of the plastic fiber molding, the felt-like fiber mixture material 3 of the plant fiber fibrils 1 and the thermoplastic fiber fibrils 2 is heated by the microwaves so that the thermoplastic resin of the fiber mixture material 3 or the fiber mixture material 300 is softened. Then, it is squeezed out by the compression so as to heighten the density of the fiber mixture material 3 or the fiber mixture material 300 and to integrate them. Moreover, it is compressed and cooled at the same time so as to be formed in the desired density of the fiber mixture material 3 or the fiber mixture material 300A. When it is compressed and cooled at the same time, the thermoplastic resin is hardened from its outside. However, distortion concurrent with the hardening of the thermoplastic resin is absorbed by the plant fibers. Therefore, a desired molding including a board can be formed using a desired mold or die.

According to still another aspect of the above embodiment of the plastic fiber molding, the plant fiber fibrils 1 are mixed in the thermoplastic fiber fibrils 2 including the PE (polyethylene) and PVC (polyvinyl chloride) or the like, for example, thereby making the felt-like fiber mixture material 3 or fiber mixture material 300. Then, it is heated by the microwaves so as to soften the fiber mixture material 3 or the fiber mixture material 300. Moreover, it goes through the compression molding so as to be integrated partially. Thereafter, it is cooled and compressed so as to be molded into a desire shape. Therefore, if the fiber mixture material is compressed while the temperature at the side of the plant fibers is made higher, the thermoplastic resin seeps in the plant fibers, is intertwined with the plant fibers and sticks on the surface of the plant fibers. Consequently, the mixture material 3A or the mixture material 300A transformed from the fiber mixture material 3 or the fiber mixture material 300 can be integrated firmly and rigidly. Moreover, it can be formed into a desired shape. Furthermore, it is possible to restrain a plastic phase separating phenomenon between PE and PVC.

According to still another aspect of the above embodiment of the plastic fiber molding, the plastic fiber molding is compressed by repeating the heat compression and the cool compression one or more times. Therefore, a predetermined treatment can be done in a short period of time, while lowering a temperature and easing the internal strain.

According to still another aspect of the above embodiment of the plastic fiber molding, two or three layers (second embodiment) or more layers are formed as the layers that have different ratio of the plant fiber fibrils 1 and the thermoplastic fiber fibrils 2 making the fiber mixture material 3 or the fiber mixture material 300 in a low density felt state. Therefore, there can be obtained a plastic fiber molding having a desired mechanical strength, a desired specific gravity and a desired elasticity. Consequently, there can be supplied a molding having a designed strength in accordance with a use.

According to one aspect of the above embodiment of the manufacturing method of the plastic fiber molding, the felt-like fiber mixture material 3 or fiber mixture material 300 made of the plant fiber fibrils 1 and the thermoplastic fiber fibrils 2 is heated by the microwaves. Then, the plant fibers in the fiber mixture material 3 or the fiber mixture material 300 is particularly made in a high-temperature state. The mixture material is compressed and molded into a predetermined shape. Thus, the internal strain is absorbed by the plant fibers. Moreover, the mixture material 3A or the mixture material 300A transformed from the fiber mixture material 3 or the fiber mixture material 300A is integrated. Consequently, if the mixture material is compressed while the temperature particularly at the plant fiber side is made higher, the thermoplastic resin sinks in the plant fibers, is entangled with the plant fibers and sticks to the surface of the plant fibers. As a result, the fiber mixture material can be integrated firmly and rigidly and molded into a desired shape.

According to another aspect of the above embodiment of the manufacturing method of the plastic fiber molding, the felt-like fiber mixture material 3 made of the plant fiber fibrils 1 and the thermoplastic fiber fibrils 2 is heated by the microwaves. Particularly, the lignin contained in the plant fiber fibrils 1 is solubilized by the internal heat generation of the plant fiber fibrils 1. The mixture material is compressed so as to be joined to the thermoplastic fiber fibrils 2, while being molded into a fixed shape. Thus, the internal strain is absorbed by the plant fibers and the fiber mixture material is integrated. Consequently, if the fiber mixture material is compressed while the temperature particularly at the plant fiber side is made higher, the fiber mixture material is cooled and compressed while the thermoplastic resin seeps in the plant fibers, is entangled with the plant fibers and stick to the surface of the plant fibers. As a result, the fiber mixture material 3A or the mixture material 300A transformed from the fiber mixture material 3 or the mixture material 300 can be integrated firmly and rigidly. Moreover, the plastic fiber molding can be formed in a desired shape.

According to another aspect of the above embodiment of the manufacturing method of the plastic fiber molding, the plant fiber fibrils 1 are mixed in the thermoplastic fiber fibrils 2 including the PE (polyethylene) and PVC (polyvinyl chloride) or the like, for example, thereby making the felt-like fiber mixture material 3. Then, it is heated by the microwaves so as to soften the fiber mixture material 3. Moreover, it goes through the compression molding so as to be integrated. Thereafter, it is compressed so as to be molded into a desire shape. Thus, the internal strain is absorbed by the plant fibers. Moreover, the mixture material 3A or the mixture material 300A transformed from the fiber mixture material 3 or the fiber mixture material 300 can be formed into a desired shape by cooling and compressing so as to be integrated. Consequently, the thermoplastic resin is hardened from its outside at the time of cooling and compressing. At that time, the distortion concurrent with the hardening of the thermoplastic resin is absorbed by the plant fibers. Therefore, it is possible to form a molding including a board by use of a desired mold or die.

According to still another aspect of the above embodiment of the manufacturing method of the plastic fiber molding, the heat compression and the cool compression are repeated one or more times. Therefore, the plastic fiber molding can be deformed step by step, so that it is possible to mold it while reducing the internal strain. Thus, the internal strain can be eased.

According to still another aspect of the above embodiment of the manufacturing method of the plastic fiber molding, the microwaves have an output of 5 KW or more. Therefore, the fiber mixture material can be integrated by compressing particularly the plant fibers in a high-temperature state, forming it into a desired shape by cooling and compressing and making the plant fibers absorb the internal strain. Accordingly, the dissolvability of the thermoplastic resin around the plant fibers is improved by making the temperature particularly at the plant fiber side. Then, the fiber mixture material experiences the compressed at such state, so that the thermoplastic resin sinks in the plant fibers, is entangled with the plant fibers and stick to the surface of the plant fibers. Thus, it is possible to integrate firmly and rigidly the mixture material 3A or the mixture material 300A transformed from the fiber mixture material 3 or the fiber mixture material 300, while molding it into a desire shape.

According to one aspect of the above embodiment of the manufacturing apparatus for the plastic fiber molding, the felt-like fiber mixture material 3 or fiber mixture material 300 made of the plant fiber fibrils 1 and the thermoplastic fiber fibrils 2 is heated by the microwaves so that the fiber mixture material 3 or the fiber mixture material 300 is softened. Moreover, the mixture material 3A or the mixture material 300A transformed from the fiber mixture material 3 or the fiber mixture material in the softened state is compressed. Thereafter, the mixture material is compressed and cooled so that the fiber mixture material 3A or the fiber mixture material 300A is integrated, while being molded into a desired shape. Particularly, the lignin contained in the plant fiber fibrils 1 is solubilized by the internal heat generation of the plant fiber fibrils 1. Moreover, the plant fiber fibrils 1 are joined to the plastic fiber fibrils 2 by compression. As a result, the thermoplastic resin is entangled with the plant fibers and stuck on the surface of the plant fibers. Thus, the fiber mixture material goes through the heat or cool compression in that state. Therefore, the fiber mixture material can be integrated firmly and rigidly. Moreover, the plastic fiber molding can be formed in a desired shape.

According to another aspect of the above embodiment of the manufacturing apparatus for the plastic fiber molding, the felt-like fiber mixture material 3 or fiber mixture material 300 made of the plant fiber fibrils 1 and the thermoplastic fiber fibrils 2 is heated by the microwaves so that the fiber mixture material 3 or the fiber mixture material 300 is softened. Moreover, the mixture material 3A or the mixture material 300A transformed from the fiber mixture material 3 or the fiber mixture material is integrated by compression. Thereafter, the mixture material is compressed and cooled so that the fiber mixture material is molded into a desired shape. Particularly, the lignin contained inside is solubilized by the internal heat generation of the plant fiber fibrils 1. Moreover, the plant fiber fibrils 1 are joined to the plastic fiber fibrils 2 by compression. As a result, the thermoplastic resin seeps in the plant fibers, is entangled with the plant fibers and sticks to the surface of the plant fibers. Thus, the fiber mixture material goes through the cool compression in that state. Therefore, the fiber mixture material can be integrated firmly and rigidly. Moreover, the plastic fiber molding can be formed in a desired shape.

According to still another aspect of the above embodiment of the manufacturing apparatus for the plastic fiber molding, the felt-like fiber mixture material 3 or fiber mixture material 300 made of the plant fiber fibrils 1 and the thermoplastic fiber fibrils 2 is heated by the microwaves so that the fiber mixture material 3 or the fiber mixture material 300 is softened. Moreover, the mixture material 3A or the mixture material 300A transformed from the fiber mixture material 3 or the fiber mixture material 300 is integrated by compression. Thereafter, the mixture material is compressed and cooled so that the fiber mixture material is integrated firmly and rigidly while being molded into a desired shape. Used at the time of compression is the pair of the separating means 6A and the separating means 8 disposed between the upper and lower pair of the pressure plate 32 and the pressure plate 33 and the upper and lower pair of the pressure plates 42a, 42b, 42c and the pressure plates 43a, 43b, 43c and the mixture material 3A or the mixture material 300A. Then, the fiber mixture material 3A or the fiber mixture material 300A is moved while being held between the pair of the separating means 44A and the separating means 45. Therefore, a finished surface can be determined by the separating means 44A and the separating means 45. Moreover, it is possible to change the upper and lower pair of the pressure plate 32 and the pressure plate 33 and the pressure plates 42a, 42b, 42c and the pressure plates 43a, 43b, 43c in a state where it is not completely cooled. Consequently, it is possible to repeat heating and cooling, thereby lessening a heat loss for repeating heating and cooling. Moreover, it enables the fiber mixture material 3A or the fiber mixture material 300A to be moved while being integrated and molded firmly and rigidly.

According to still another aspect of the above embodiment of the manufacturing apparatus for the plastic fiber molding, the felt-like fiber mixture material 3 or fiber mixture material 300 made of the plant fiber fibrils 1 and the thermoplastic fiber fibrils 2 is heated by irradiation of the microwaves so that the mixture material 3A or the mixture material 300A transformed from the fiber mixture material 3 or the fiber mixture material 300 is softened. Moreover, the mixture material 3A or the mixture material 300A is integrated by compression. Thereafter, the mixture material is compressed and cooled so that the fiber mixture material is molded into a desired shape. Used at the time of compression are the pair of the separating means 6A and the separating means 8 and the pair of the separating means 44A and the separating means 45 respectively disposed between the upper and lower pair of the pressure plate 32 and the pressure plate 33 and the upper and lower pair of the pressure plates 42a, 42b, 42c and the pressure plates 43a, 43b, 43c and the mixture material 3A or the mixture material. Then, the fiber mixture material 3A or the fiber mixture material 300A is compressed and moved while being held between the pair of the separating means 44A and the separating means 45. Therefore, a finished surface can be determined by the separating means 44A and the separating means 45. Moreover, it is possible to change the upper and lower pair of the pressure plate 32 and the pressure plate 33 and the pressure plates 42a, 42b, 42c and the pressure plates 43a, 43b, 43c in a state where it is not completely cooled. Consequently, it is possible to repeat heating and cooling. Moreover, it enables the fiber mixture material 3A or the fiber mixture material 300A to be integrated firmly and rigidly and molded into a desired shape.

According to still another aspect of the above embodiment of the manufacturing apparatus for the plastic fiber molding, the felt-like fiber mixture material 3 or fiber mixture material 300 made of the plant fiber fibrils 1 and the thermoplastic fiber fibrils 2 is heated by the microwaves so that the mixture material 3A or the mixture material 300A transformed from the fiber mixture material 3 or the fiber mixture material 300 is softened. Moreover, the mixture material 3A or the mixture material 300A is integrated by compressing and cooling so as to be molded into a desired shape. In such apparatus, the attenuating device 23 is provided at the entrance and the exit of the area for heating by the microwaves so as to attenuate the microwaves. Moreover, the apparatus is capable of continuously feeding the fiber mixture material 3A or the fiber mixture material 300A. Therefore, it is possible to configure the area for heating and softening the felt-like fiber mixture material 3 or fiber mixture material 300 made of the plant fiber fibrils 1 and the thermoplastic fiber fibrils 2 and then compressing the fiber mixture material 3A or the mixture material 300A as one section of a successively formed apparatus. Thus, it is possible to arrange successively and adjacently the structure for melting and compressing the fiber mixture material 3A or the mixture material 300A and the structure for compressing and cooling the fiber mixture material 3A or the mixture material 300A.

According to still another aspect of the above embodiment of the manufacturing apparatus for the plastic fiber molding, the side plates 9 extending in the direction perpendicular to the vertical direction are used when the mixture material 3A or the mixture material 300A transformed from the fiber mixture material 3 or the fiber mixture material that is heated and softened by the microwaves and heated, is cooled and compressed so as to be integrated. Therefore, there can be provided ones having a desired shape regardless of a continuous forming or an injection molding. Particularly, it is possible to continuously form ones having a predetermined width and shape.

According to still another aspect of the above embodiment of the manufacturing apparatus for the plastic fiber molding, the raw material of the thermoplastic fiber fibrils 2 is PE (polyethylene) and PVC (polyvinyl chloride). The plant fiber fibrils 1 are mixed in the thermoplastic fiber fibrils 2 including the PE (polyethylene) and PVC (polyvinyl chloride), thereby making the felt-like fiber mixture material 3 or fiber mixture material 300. Then, it is heated by the microwaves so as to soften the fiber mixture material 3 or the fiber mixture material 300. Moreover, it goes through the compression molding so as to be integrated. Thus, the fluidity of the thermoplastic resin around the plant fibers is improved. Consequently, when the compression is performed in that state, the thermoplastic resin sinks in the plant fibers, is entangled with the plant fibers and stick to the surface of the plant fibers. Therefore, the mixture material 3A or the mixture material 300A can be integrated firmly and rigidly. Moreover, it can be formed into a desired shape. Furthermore, it is possible to restrain a plastic phase separating phenomenon between PE and PVC.

According to still another aspect of the above embodiment of the manufacturing apparatus for the plastic fiber molding, the plastic fiber molding is the plastic fiber molded board. Therefore, it is possible to form a board material having a desire thickness and a desired width by a continuous molding.

In the plastic fiber molding that is manufactured by the above embodiment of the manufacturing apparatus for the plastic fiber molding, there is a premise that the fiber mixture material 3 of the low density composed of the plant fiber fibrils 1 and the thermoplastic fiber fibrils 2 as the characteristics of the invention is heated by the microwaves and then goes through the compression-heating by the pressure plates 32, 33, 32a, 33a, 32b, 33b or the pressure plates so as to squeeze out the lignin from the plant fiber fibrils and join them to the thermoplastic fiber fibrils 2. However, it is possible to heat it to such a temperature as the thermoplastic fiber fibrils 2 are melted and join the thermoplastic fiber fibrils 2 with each other in order to obtain a desired mechanical strength and physicochemical property.

While the heated pressure plates 31, 32 of the compression unit 30 or the heated pressure plates 32a, 33a, 32b, 33b of the heat-compression unit 30A, 30B are heated by the heater, they may be structured such that they generate heat by enlarging a pressure, in embodying the invention.

The preferred embodiments described herein are illustrative and not restrictive, the scope of the invention being indicated in the appended claims and all variations which come within the meaning of the claims are intended to be embraced therein.

1. A plastic fiber molding obtained by heating a fiber mixture material of low density composed of plant fiber fibrils and thermoplastic fiber fibrils by microwaves so as to make the fiber mixture material in a softened state, and compressing the fiber mixture material in the softened state so as to integrate the fiber mixture material and to shape the fiber mixture material into a desired shape.

2. A plastic fiber molding obtained by heating a fiber mixture material of low density composed of plant fiber fibrils and thermoplastic fiber fibrils by microwaves so as to make the fiber mixture material in a softened state, compressing and heating the fiber mixture material, and compressing and cooling the fiber mixture material so as to integrate the fiber mixture material and to shape the fiber mixture material into a desired shape.

3. A plastic fiber molding obtained by mixing plant fiber fibrils into thermoplastic fiber fibrils so as to make a fiber mixture material of low density, heating the fiber mixture material by microwaves so as to make the fiber mixture material in a softened state, compressing the fiber mixture material, and compressing and cooling the fiber mixture material so as to form the fiber mixture material into a desired shape.

4. A plastic fiber molding according to claim 1, in which the fiber mixture material is compressed by repeating a heat compression and a cool compression one or more times.

5. A plastic fiber molding according to claim 1, in which the plastic fiber molding comprises plural layers, each of the plural layers having a different ratio of the plant fiber fibrils and the thermoplastic fiber fibrils and the plural layers forming the fiber mixture material of low density.

6. A plastic fiber molding according to claim 1, in which the plant fiber fibrils and the thermoplastic fiber fibrils are joined with each other by heating the fiber mixture material of low density composed of the plant fiber fibrils and the thermoplastic fiber fibrils and then compressing and heating the fiber mixture material by pressure plates so as to squeeze out lignin from the plant fiber fibrils.

7. A plastic fiber molding according to claim 1, in which the plastic fiber molding has unmelted thermoplastic fiber fibrils mixed therein, and the unmelted thermoplastic fiber fibrils are softened when receiving an external heat so as to enable the plastic fiber molding to contract.

8. A manufacturing method of a plastic fiber molding comprising the steps of:
heating a fiber mixture material of low density composed of plant fiber fibrils and thermoplastic fiber fibrils by microwaves so as to make the fiber mixture material in a softened state; and
compressing the fiber mixture material in the softened state so as to weld adjacent portions of the plant fiber fibrils and the thermoplastic fiber fibrils and to shape the fiber mixture material so that part of the fiber mixture material is mixed as non-welded fibers.

9. A manufacturing method of a plastic fiber molding comprising the steps of:
heating a fiber mixture material of low density composed of plant fiber fibrils and thermoplastic fiber fibrils by microwaves so as to make the fiber mixture material in a softened state;
compressing the fiber mixture material so as to integrate the fiber mixture material: and
then cooling an compressing the fiber mixture material at the same time.

10. A manufacturing method of a plastic fiber molding comprising the steps of:
mixing plant fiber fibrils and thermoplastic fiber fibrils so as to make a fiber mixture material of low density;
heating the fiber mixture material by microwaves so as to make the fiber mixture material in a softened state; and
compressing and cooling the fiber mixture material so as to integrate the fiber mixture material.

11. A manufacturing method of a plastic fiber molding according to claim 8, in which the fiber mixture material is compressed by repeating a heat compression and a cool compression one or more times.

12. A manufacturing method of a plastic fiber molding according to claim 8, in which the microwaves have an output of 5 KW or more.

13. A manufacturing method of a plastic fiber molding according to claim 8, in which the compressing step comprises a heat compression by pressure plates so as to squeeze out lignin from the plant fiber fibrils and to join the plant fiber fibrils to the thermoplastic fiber fibrils.

14. A manufacturing method of a plastic fiber molding according to claim 8, in which the compressing step is carried out to such a degree as unmelted thermoplastic fiber fibrils are mixed in the plastic fiber molding and the unmelted thermoplastic fiber fibrils enable the plastic fiber molding to contract when receiving an external heat.

15. A manufacturing apparatus of a plastic fiber molding comprising:
a heating unit for heating a fiber mixture material composed of plant fiber fibrils and thermoplastic fiber fibrils by microwaves so as to make the fiber mixture material in a softened state; and
a compression unit for compressing the fiber mixture material so as to form the fiber mixture material into a desired shape.

16. A manufacturing apparatus of a plastic fiber molding comprising:
a heating unit for heating a fiber mixture material composed of plant fiber fibrils and thermoplastic fiber fibrils by microwaves so as to make the fiber mixture material in a softened state; and
a cool-compression unit for cooling and compressing the fiber mixture material so as to form the fiber mixture material into a desired shape.

17. A manufacturing apparatus of a plastic fiber molding comprising:
a heating unit for heating a fiber mixture material composed of plant fiber fibrils and thermoplastic fiber fibrils by microwaves so as to make the fiber mixture material in a softened state;
a compression unit for compressing and integrating the fiber mixture material, the compression unit has a first pair of upper and lower pressure plates of a predetermined shape and a first pair of separating means disposed between the first pair of the upper and lower pressure plates and the fiber mixture material; and
a cool-compression unit for cooling and compressing the fiber mixture material so as to form the fiber mixture material into a desired shape, the cool-compression unit has a second pair of upper and lower second pressure plates of a predetermined shape and a second pair of separating means disposed between the first pair of the upper and lower second pressure plates and the fiber mixture material;
wherein the fiber mixture material is compressed and formed while held between the first pair of the separating means in the compression unit and the fiber mixture material is compressed and formed while held between the second pair of the separating means in the cool-compression unit.

18. A manufacturing apparatus of a plastic fiber molding comprising:
a heating unit for heating a fiber mixture material composed of plant fiber fibrils and thermoplastic fiber fibrils by microwaves so as to make the fiber mixture material in a softened state; and
a compression unit for compressing and integrating the fiber mixture material so as to form the fiber mixture material into a desired shape, the compression unit has a pair of upper and lower pressure plates of a predetermined shape and a pair of separating means disposed between the pair of the upper and lower pressure plates and the fiber mixture material;
wherein the fiber mixture material is fed while held between the pair of the separating means in the compression unit.

19. A manufacturing apparatus of a plastic fiber molding comprising:
a heating unit for heating a fiber mixture material composed of plant fiber fibrils and thermoplastic fiber fibrils by microwaves so as to make the fiber mixture material in a softened state; and
a compression unit for compressing and integrating the fiber mixture material so as to form the fiber mixture material into a desired shape, the compression unit has a pair of upper and lower pressure plates of a predetermined shape and a pair of separating means disposed between the pair of the upper and lower pressure plates and the fiber mixture material;
wherein the fiber mixture material is compressed and fed while held between the pair of the separating means in the compression unit.

20. A manufacturing apparatus of a plastic fiber molding comprising:
a heating unit for heating a fiber mixture material composed of plant fiber fibrils and thermoplastic fiber fibrils by microwaves so as to make the fiber mixture material in a softened state;
a compression unit for compressing and integrating the fiber mixture material so as to form the fiber mixture material into a desired shape; and
an attenuating unit, provided at an entrance and an exit of a heating area of the heating unit, for attenuating the microwaves so that the fiber mixture material is continuously fed thereat.

21. A manufacturing apparatus of a plastic fiber molding according to claim 15 further comprising side plates extending in a direction perpendicular to a vertical direction, the side plates being provided respectively at the heating unit and the compression unit.

22. A manufacturing apparatus of a plastic fiber molding according to claim 15, in which a plastic used for the thermoplastic fiber fibrils is one of a polyethylene and a polyvinyl chloride.

23. A manufacturing apparatus of a plastic fiber molding according to claim 15, in which the compression unit has pressure plates for compressing and heating the fiber mixture material in the softened state so that lignin is squeezed out from the plant fiber fibrils so as to join the plant fiber fibrils to the thermoplastic fiber fibrils.

24. A manufacturing apparatus of a plastic fiber molding according to claim 15, in which the compression unit compresses the fiber mixture material in the softened state to such a degree as unmelted thermoplastic fiber fibrils are mixed in the plastic fiber molding and enable the plastic fiber molding to contract when receiving an external heat.

25. A plastic fiber molding according to claim 1, in which the plastic fiber molding is a plastic fiber molded board.

26. A manufacturing method of a fiber molding according to claim 8, in which the plastic fiber molding is a plastic fiber molded board.

27. A manufacturing apparatus of a plastic fiber molding according to claim 15, in which the plastic fiber molding is a plastic fiber molded board.
